(19) United States
(12) Patent Application Publication
(10) Pub. No.: US 2025/0384632 A1
(43) Pub. Date: Dec. 18, 2025

(54) METHODS AND APPARATUSES FOR ENHANCING THREE-DIMENSIONAL MODELS FROM INTRAORAL SCANNING

(71) Applicant: Align Technology, Inc., San Jose, CA (US)

(72) Inventors: Maayan MOSHE, Ra' anana (IL); Gal PELEG, Kiryat-ono (IL); Michael LELLOUCH, Tel Aviv (IL)

(21) Appl. No.: 19/242,921

(22) Filed: Jun. 18, 2025

Related U.S. Application Data
(60) Provisional application No. 63/661,554, filed on Jun. 18, 2024.

(51) Int. Cl. G06T 19/00; A61C 9/00; G06T 7/00; G06T 17/20

(52) U.S. Cl. CPC G06T 19/00; A61C 9/006; G06T 7/0014; G06T 17/20; G06T 2207/10048; G06T 2207/20021; G06T 2207/20084; G06T 2207/30036; G06T 2210/41

(57) ABSTRACT

Methods and apparatuses that may improve the accuracy of three-dimensional (3D) models may compare one or more geometric properties from corresponding 2D images. The 3D model (e.g., mesh model) and the 2D images may be taken from the same scan, e.g., an intraoral scan, of the subject's dentition. In some examples normals of the 3D mesh model may be compared to a normals map derived from the 2D image(s). Alternatively or additionally, these methods and apparatuses may be configured to compare a depth map generated from a 2D image to improve the 3D digital mesh model.

### CLAIM OF PRIORITY

This patent application claims priority to U.S. Provisional Patent Application No. 63/661,554, titled “METHODS AND APPARATUSES FOR ENHANCING THREE-DIMENSIONAL MODELS FROM INTRAORAL SCANNING,” filed on Jun. 18, 2024, and incorporated by reference in its entirety herein.

### BACKGROUND

Intraoral scanners are capable of generating detailed three-dimensional models of a subject's dentition, and may scan the subject's teeth in real time, as the scanning cameras are moved relative to the subject's teeth. Although intraoral scanners may be surprisingly accurate even when rapidly scanned over the subject's teeth, the resolution of such 3D models may be lower than desired. This may lead to a lack of some fine details, even when scanning with multiple cameras simultaneously.

It would be beneficial to provide methods and apparatuses that may be used with or integrated into intraoral scanning to improve the resulting scanned digital models of the teeth. Described herein are methods and apparatuses that may improve intraoral scanning and analysis/interpretation of intraoral scans and resulting 3D models to the subject's dentition.

### SUMMARY OF THE DISCLOSURE

Described herein are methods and apparatuses (e.g., devices, and systems, including intraoral scanners and software) for modifying a three-dimensional digital model of a subject's dentition generated from an intraoral scan of the teeth using two-dimensional images. The 2D images may be in any appropriate modality and/or wavelength, including white light, structured light or other modalities (e.g., confocal, time of flight, etc.). These methods and apparatuses may use images taken while scanning. For convenience, these images may generally be referred to herein as white light images, but it should be understood that they may be any optical modality, including single non-visible light images (e.g., near-infrared images, florescent images, etc.). Alternatively, in some cases, the images may be limited to white light images taken in the visible light spectrum (e.g., a color image). In some cases, the white light image may be taken from a region or portion of a structured light image (or in some cases a confocal image). In some cases the white light image may be taken separately from the structured light images (and/or confocal images) taken by the intraoral scanner to generate the 3D representation of the scan. Optionally, in some cases the white light image may be taken using ambient light. Alternatively or additionally, the white light image may be taken by the application of light (e.g., LED light) from the scanner. An intraoral scan of a subject's dentition taken using structure light or other modalities (confocal, time of flight, etc.) may generate a surface which may be improved using one or more white light images of the subject's dentition. Depth maps may be generated for each of the one or more white light images (all or a portion, e.g., a low angel portion of the WL image, relative to a light source), and the resulting one or more depth maps may be used to improve the surface of the digital model.

In general, the methods and apparatuses (e.g., systems and devices, including software, hardware and/or firmware) described herein may modify a 3D digital model of a subject's dentition using a two-dimensional (2D) image, and more specifically, may use one or more properties derived from a first-order and/or second-order fundamental form from the 2D image(s) to modify the 3D digital model. The one or more properties derived from the 2D images may be, for example, depth (e.g., a depth map), normals (e.g., a surface normal map), mean curvature (e.g., a curvature map), etc.

For example, one or more regions of one or more white light images taken relative to a camera positions may be used to generate depth maps to improve the scanned model. Improvements can consist of hole filling, resolution improvements, surface continuation, etc.

Initial scanning with structure light or other modalities (as confocal, time of flight, etc.) and images with camera positions may be used to improve the scanned dental model, e.g., from an intraoral scanner. Improvements can include filling one or more holes or gaps, improving resolution, and/or improving surface continuity. These methods and apparatuses may solve the problem of insufficient details, resolution, and/or accuracy of scans acquired by traditional scanning method which could be confocal, structure light or any other scanning method.

In general, the techniques described herein may solve problems of insufficient details, resolution, and/or accuracy acquired by the basic scanning method, including for scanning methods such as confocal scanning, structure light scanning, or any other scanning technique. In some examples the methods and apparatuses described herein may receive as input an initial 3D digital surface model generated from an intraoral scan, one or more image(s), e.g., taken with, during and/or as part of the intraoral scan, with camera positions, and camera intrinsic parameters. A subset of the provided images may be selected from the provided images. In some cases the subset of provided images may include one or more portions or regions of the provided images. In some cases images making up the subset of provided images may be selected based on correspondence to a region of the initial 3D digital surface model, such as regions that include gaps, holes, etc.

In some examples, these methods may infer the depth and therefore surface in regions of the 3D digital surface formed by the intraoral scanning that are inaccurate or irregular, including regions having holes, etc. This may be done by inferring the local properties of a region based on the depth map derived from the corresponding white light image. For example, if there is an area of the 3D digital surface model (e.g., mesh) that is irregular, this region may be identified from one or more corresponding white light regions that may be used to predict the depth of the region, the depth may then be used to improve the predicted surface.

In some examples the method described here may compensate for regions where the intraoral scan and resulting 3D surface model are irregular or inaccurate (such as regions that are shadowed, e.g., interproximal regions, gingal/tooth margin regions, etc.). These methods and apparatuses may be particularly useful for sparse regions, e.g., regions where the density of pixels (voxels in 3D) are below a threshold value. In some cases these methods may use both the depth map taken from the white light images and a normal mapping of the same region. The use of both the depth map and the normal map in all or some of these regions may enhance the images.

For example, the method and/or apparatus may generate a normal map (e.g., a map of normal) for each of the images (or image regions) in the subset of images, corresponding to each image, e.g., by sampling the surface. In some examples, a normal may be determined for each pixel, for which a camera ray intersects the surface. The normal at this stage may be in the camera coordinate system. A depth map may be generated for each image in the subset of images. All or some of the individual pixels (or regions of pixels) in the images may be identified by segmentation, e.g., to distinguish tooth, gingiva, etc. For example, images may be segmented by a trained machine learning agent (e.g., a trained neural network), and each pixel may include a relevant label for that pixel based on the segmentation.

In some cases, each image may be divided up into regions. For example, each image may be divided into an almost square grid in the opening angle. For each grid point in the image, the method or apparatus may be sampled, including sampling of the initial normal map, and label map to an image for which the grid point is the image center (closest point of screen to camera pinhole) and the opening angle is fixed (typically 30 degrees). The sampling is performed by perspective warping.

The method and apparatus may apply a pretrained machine learning agent (e.g., a trained neural network) to predict the desired surface normals from the image(s). The method and apparatus may then sample back to the surface normal from the predicted surface normals. Optionally, in some cases as described herein, the normals may be integrated to get the final depth map and the apparatus and method may constrain the final surface so that it must remain relatively close to the initial surface in regions in which it is known that the initial surface is fairly accurate, e.g., densely sampled regions, which will have a confidence level that is greater than a confidence threshold. These surface normal maps may then be used to generate a depth map corresponding to each image (or groups of images) and the resulting depth map(s) may be used to produce the final 3D surface.

In any of these methods and apparatuses, a trained machine learning agent may be used to generate the normal and/or to generate the depth map (which may be derived, e.g., indirectly, from the normals). The normal are typically unitless while the depth map may include units. The trained machine learning agent may be trained using images including camera position, camera intrinsic parameters and an initial 3D surface. Initial normal maps may be generated from the corresponding image by sampling the surface. Each pixel may have a normal for which the camera ray intersects the surface. The normal may be represented at this stage in a camera coordinate system. A segmentation image may be produced. Each pixel may have the relevant label of that pixel and/or may be assigned a true or false value; e.g., true if it is rigid pixel and false if it is moving tissue or vacant pixel. The reference normal maps may be produced from reference scanner 3D model and images. Each image may therefore be divided into an almost square grid in the opening angle; for each grid point the image, initial normal map, and label map to an image may be sampled, for which the grid point is the image center (e.g., closest point of screen to camera pinhole) and the opening angle is fixed (e.g., at an angle between about 45-1 degree, e.g., 40 degrees, 35 degrees, 30 degrees, 25 degrees, etc.). The sampling may be performed by perspective warping. A data set of consistent values (e.g., normals) of the above patches of small opening angle may be prepared. The machine learning agent (e.g., network) may be trained with inputs of labels, images, and initial normal the network output is the difference of the desired normal to the initial normals, and a loss may be calculated only on rigid pixel for which we have normal from reference surface.

Thus, in some examples, the method may include creating a neural net that directly predicts depth maps. The neural net may take as an input the initial depth map (e.g., sampling of the initial existing surface) and the color image for which we want to create the improved depth maps. This neural net may output the new desired improved depth maps. The training data may be contained from scanned surfaces for which we have a good model, either by accurately scanning these by reference scanner or by achieving digital surface upon which they were manufactured.

One advantage of this technique is that it can achieve color image resolutions, which in general are much higher than other alternatives, and may do so without the need to match features between images only by estimating the normals from single image. This may be particularly beneficial in a scanner in which rays are provided in a region of interest, but too few for the resolution desired. In addition, the quality of some of these spots may be too low in the target region of interest. This means that the techniques provided above may be used not only to fill holes, but also to increase the resolution and quality of the 3D digital model (e.g., mesh). This can be achieved by utilizing the color images. By estimating the normals and integrating them as described herein, these methods and apparatuses may ensure consistency of the surface at the edges and surface continuity.

These methods and apparatuses described herein may generally 3D digital models of the dentition without causing perspective distortions. These techniques may use an opening angle window that is sufficiently small that it reduces the chance for overfitting.

Any of these methods may be performed in a ray coordinate system, and may estimate a loss function and may predict the difference of the first two components of the normals. This may allow to much more sensitivity for almost parallel surface to the camera rays.

These techniques can be used for any application for which a rough estimation of an initial surface is provided with one or more located images and are not limited to dentition. In some examples these methods may be used when scanning the face of the patient and then taking a still image of the patient's face. Furthermore, although the examples described herein are intended to refer to 3D digital models generated by intraoral scanners, any appropriate 3D digital model may be used, including but not limited to 3D digital models generated from cone beam computed tomography (CBCT) scanning or other digital scanning technique and/or system.

For example, described herein are methods comprising: dividing a three-dimensional (3D) digital model of a subject's dentition into a plurality of sub-regions; correcting the 3D digital model of the subject's dentition by, for one or more of the plurality of sub-regions: identifying a two-dimensional (2D) reference image from a plurality of 2D images of the subject's dentition; generating a depth map from the 2D reference image that is scaled to the 3D digital model of the subject's dentition; and modifying the 3D digital model by adjusting the surface of the 3D digital model using the scaled depth map; and outputting the modified 3D digital model. These methods may be methods for modifying a three-dimensional digital model of a subject's dentition, methods for filling gaps in a 3D digital model, intraoral scanning methods, and/or methods for making a dental appliance. Also described herein are apparatuses configured to perform these methods in an automated or semi-automated manner.

Any of these methods may include determining areas of the 3D digital model to modify, wherein correcting the 3D digital model of the subject's dentition comprises correcting the sub-regions corresponding to the determined areas of the 3D digital model. Determining areas of the 3D digital model to modify may comprise identifying one or more holes in the 3D digital model.

The 3D digital model may be generated from an intraoral scan. The 2D images (including the 2D reference image) may be taken (e.g., scanned) at approximately the same time. The 2D images may be taken before (including immediately before), during, or after (including immediately after) the intraoral scan generating the 3D digital model. In some cases the 2D images may be taken concurrently with the intraoral scan, e.g., as part of the intraoral scan. For example, the plurality of 2D images of the subject's dentition may be taken at the same time as the 3D digital model.

Identifying the two-dimensional (2D) reference image from the plurality of 2D images of the subject's dentition may include selecting the 2D reference image from one of the plurality of 2D images having a maximum pixel area corresponding to the sub-region.

The 2D reference image may be any appropriate image. In some cases the 2D images (including the 2D reference image) may be a white light image (e.g., a color image), a near-infrared image, etc. In some cases the 2D images may be taken from (e.g., extracted from) an intraoral scan image, including part of a confocal and/or structured light image. For example, the 2D reference image may be an illuminated portion of a structured light image.

Identifying the 2D reference image from the plurality of 2D image of the subject's dentition may comprise selecting the 2D reference image from one of the plurality of 2D images that best matches the portion of the 3D digital model being examined. For example, identifying the 2D reference image may include selecting, from the plurality of 2D images, an image having a minimum camera angle between a portion of the 2D reference image corresponding to the sub-region.

Any of these methods generating the depth map that is scaled to the 3D digital model of the subject's dentition may include using a trained machine learning agent to generate the depth map. For example, the method may include selecting the trained machine learning agent using a diffusion model.

Alternatively or additionally, any of these methods may include generating the depth map that is scaled to the 3D digital model by generating a normals map from the 2D reference image and scaling the depth map to the 3D digital model using the normals map. This may include generating the normal map by dividing the 2D reference image into a plurality of partial images having opening camera angles of 50 degrees or less (e.g., 45 degrees or less, 40 degrees or less, 35 degrees or less, 30 degrees or less, 25 degrees or less, etc.) and transforming the partial images using homography to normalize the angle difference and the normals to form the normals map.

Any of these methods may include modifying the 3D digital model by adjusting the surface of the 3D digital model using the scaled depth map comprises projecting the depth map onto the 3D digital model.

The methods described herein may include outputting the modified 3D digital model, e.g., by displaying the modified 3D digital model, and/or transmitting the modified 3D digital model, etc.

Any of these methods may include forming one or more (e.g., a series) of dental appliances using the modified 3D digital model. For example, any of these methods may include manufacturing a dental appliance using the modified 3D digital model, including, but not limited to, using a direct fabrication technique to form the modified 3D digital model. For example, any of these methods may include generating treatment plans to treat the patient's dentition using the modified 3D digital model. This may include generating one or more appliances to perform the treatment plan. As used herein, forming the one or more dental appliances (e.g., aligners, palatal expanders, retainers, etc.) may include generating a digital file describing the one or more appliances; the digital file may be used in a direct fabrication technique, e.g., extrusion, 3D printing, casting, machining, etc. (including stereolithography, thermoplastic extrusion methods, and laser sintering).

For example, a method as described herein may include: determining areas of a three-dimensional (3D) digital model to modify; dividing at least the areas of the 3D digital model of a subject's dentition to be modified into a plurality of sub-regions; correcting the 3D digital model of the subject's dentition by, for each of the plurality of sub-regions: identifying a two-dimensional (2D) reference image from a plurality of 2D images of the subject's dentition wherein the plurality of 2D images of the subject's dentition are taken at the same time as the 3D digital model; generating a depth map from the 2D reference image that is scaled to the 3D digital model of the subject's dentition by: generating a normals map from the 2D reference image and scaling the depth map to the 3D digital model using the normals map; and modifying the 3D digital model by adjusting the surface of the 3D digital model using the scaled depth map; and outputting the modified 3D digital model.

Also described herein are computer-readable storage medium comprising instructions which, when executed by a computer, cause the computer to carry out any of the methods described herein.

Also described herein are apparatuses (e.g., devices and systems, including software and/or firmware) for performing any of these methods. These systems may include one or more processors and memory storing instructions (e.g., a program) for performing the method using the processor. A processor may include hardware that runs the computer program code. The term ‘processor’ may include a controller and may encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

In any of these apparatuses, the system may be part of or may include an intraoral scanner. For example, described herein are systems comprising: an intraoral scanner configured to generate an initial three-dimensional (3D) digital surface model of the subject's dentition (e.g., using structured light or other modalities); an image capture module configured to obtain one or more white light images of the subject's dentition during or as part of the intraoral scan; a processing unit comprising a memory storing computer-program instructions, that, when executed by the one or more processors, perform a computer-implemented method comprising: dividing a three-dimensional (3D) digital model of a subject's dentition into a plurality of sub-regions; correcting the 3D digital model of the subject's dentition by, for each of the plurality of sub-regions: identifying a two-dimensional (2D) reference image from a plurality of 2D images of the subject's dentition; generating a depth map from the 2D reference image that is scaled to the 3D digital model of the subject's dentition; and modifying the 3D digital model by adjusting the surface of the 3D digital model using the scaled depth map; and outputting the modified 3D digital model.

The computer-implemented method may include: determining areas of the 3D digital model to modify, wherein correcting the 3D digital model of the subject's dentition comprises correcting the sub-regions corresponding to the determined areas of the 3D digital model. As mentioned above, determining areas of the 3D digital model to modify may include identifying one or more holes in the 3D digital model. The 3D digital model may be generated from an intraoral scan. Identifying the two-dimensional (2D) reference image from the plurality of 2D images of the subject's dentition may comprise selecting the 2D reference image from one of the plurality of 2D images having a maximum pixel area corresponding to the sub-region. The plurality of 2D images of the subject's dentition may be taken at the same time as the 3D digital model. The 2D reference image may be a white light image. Identifying the 2D reference image from the plurality of 2D image of the subject's dentition may comprise selecting the 2D reference image from one of the plurality of 2D images having a minimum camera angle between a portion of the 2D reference image corresponding to the sub-region. Generating the depth map that is scaled to the 3D digital model of the subject's dentition may comprise using a trained machine learning agent to generate the depth map. The trained machine learning agent may be trained using a diffusion model. Generating the depth map that is scaled to the 3D digital model may comprise: generating a normals map from the 2D reference image and scaling the depth map to the 3D digital model using the normals map. Generating the normals map may comprise dividing the 2D reference image into a plurality of partial images having opening camera angles of 30 degrees or less and transforming the partial images using homography to normalize the angle difference and the normals to form the normals map. Modifying the 3D digital model by adjusting the surface of the 3D digital model using the scaled depth map may comprise projecting the depth map onto the 3D digital model.

Outputting the modified 3D digital model may comprise displaying the modified 3D digital model. Any of these method may include manufacturing a dental appliance using the modified 3D digital model.

Also described herein are systems that may be part of, or may be used in conjunction with, an intraoral scanner. For example, described herein are systems that include an intraoral scanner configured to generate an initial three-dimensional (3D) digital surface model of the subject's dentition; an optional image capture module that is configured to obtain one or more white light images of the subject's dentition during or as part of the intraoral scan; a processing unit comprising a memory storing computer-program instructions, that, when executed by the one or more processors, perform a computer-implemented method comprising: determining areas of a three-dimensional (3D) digital model to modify; dividing at least the areas of the 3D digital model of a subject's dentition to be modified into a plurality of sub-regions; correcting the 3D digital model of the subject's dentition by, for each of the plurality of sub-regions: identifying a two-dimensional (2D) reference image from a plurality of 2D images of the subject's dentition wherein the plurality of 2D images of the subject's dentition are taken at the same time as the 3D digital model; generating a depth map from the 2D reference image that is scaled to the 3D digital model of the subject's dentition by: generating a normals map from the 2D reference image and scaling the depth map to the 3D digital model using the normals map; and modifying the 3D digital model by adjusting the surface of the 3D digital model using the scaled depth map; and outputting the modified 3D digital model.

Any of these systems may be configured to determine the areas of the 3D digital model to modify, wherein correcting the 3D digital model of the subject's dentition comprises correcting the sub-regions corresponding to the determined areas of the 3D digital model. Determining areas of the 3D digital model to modify may include identifying one or more holes in the 3D digital model. The 3D digital model may be generated from an intraoral scan. Identifying the two-dimensional (2D) reference image from the plurality of 2D images of the subject's dentition may comprise selecting the 2D reference image from one of the plurality of 2D images having a maximum pixel area corresponding to the sub-region. The plurality of 2D images of the subject's dentition may be taken at the same time as the 3D digital model. In any of these systems, the 2D reference image is a white light image.

Identifying the 2D reference image from the plurality of 2D images of the subject's dentition may include selecting the 2D reference image from one of the plurality of 2D images having a minimum camera angle between a portion of the 2D reference image corresponding to the sub-region. Generating the depth map that is scaled to the 3D digital model of the subject's dentition may include using a trained machine learning agent to generate the depth map. The trained machine learning agent may be trained using a diffusion model.

In any of these systems, generating the depth map that is scaled to the 3D digital model may include: generating a normals map from the 2D reference image and scaling the depth map to the 3D digital model using the normals map. Generating the normals map may comprise dividing the 2D reference image into a plurality of partial images having opening camera angles of 30 degrees or less and transforming the partial images using homography to normalize the angle difference and the normals to form the normals map.

Modifying the 3D digital model by adjusting the surface of the 3D digital model using the scaled depth map may include projecting the depth map onto the 3D digital model. Outputting the modified 3D digital model may comprise displaying the modified 3D digital model. Any of these methods may include manufacturing a dental appliance using the modified 3D digital model.

For example, a system may include: an intraoral scanner configured to generate an initial three-dimensional (3D) digital surface model of the subject's dentition; a processing unit comprising a memory storing computer-program instructions, that, when executed by the one or more processors, perform a computer-implemented method comprising: determining areas of a three-dimensional (3D) digital model to modify; dividing at least the areas of the 3D digital model of a subject's dentition to be modified into a plurality of sub-regions; correcting the 3D digital model of the subject's dentition by, for each of the plurality of sub-regions: identifying a two-dimensional (2D) reference image from a plurality of 2D images of the subject's dentition wherein the plurality of 2D images of the subject's dentition are taken at the same time as the 3D digital model; generating a depth map from the 2D reference image that is scaled to the 3D digital model of the subject's dentition by: generating a normals map from the 2D reference image and scaling the depth map to the 3D digital model using the normals map; and modifying the 3D digital model by adjusting the surface of the 3D digital model using the scaled depth map; and outputting the modified 3D digital model. Optionally, and of these systems may include an image capture module configured to obtain one or more white light images of the subject's dentition during or as part of the intraoral scan.

Also described herein is software for performing the methods described herein. This software may be part of an intraoral scanner, accessed by an intraoral scanner, or independent of the intraoral scanner. Thus, the apparatuses described herein may be configured to operate separately from the intraoral scanner, either locally or remotely (e.g., on a remote server) to which intraoral scan data is transmitted. For example described herein is computer-readable storage media comprising instructions which, when executed by a computer, cause the computer to carry out the method described above, such as: dividing a three-dimensional (3D) digital model of a subject's dentition into a plurality of sub-regions; correcting the 3D digital model of the subject's dentition by, for one or more of the plurality of sub-regions: identifying a two-dimensional (2D) reference image from a plurality of 2D images of the subject's dentition; generating a depth map from the 2D reference image that is scaled to the 3D digital model of the subject's dentition; and modifying the 3D digital model by adjusting the surface of the 3D digital model using the scaled depth map; and outputting the modified 3D digital model.

In general, the methods and apparatuses (including systems, devices and software) described herein may modify the 3D model using the scaled depth map. This modification may include correcting the surface of the 3D model (e.g., to add or remove points, vertices, edges, faces, etc.). In some cases the method or apparatus may be used to correct specific regions, including in particular crowded regions, such as the regions between teeth (e.g., interproximal regions, etc.), where the resolution of 3D models may be lower. Thus, gaps, holes, opening, etc. within the 3D model may be corrected or adjusted based on the scaled depth map. Any of these methods may include displaying, storing and/or transferring the modified 3D model.

The method and apparatuses (e.g., systems, devices, etc.) described herein may also be used directly with the normals determined from the 2D images and from the 3D model, without necessarily using depth maps. Thus, described herein are methods for improving a 3D model of a subject's teeth using surface normals. For example, any of these methods may include generating, accessing or receiving a digital three-dimensional (3D) model of a subject's dentition. 3D model is (or is converted to be) a mesh representation, and specifically a triangular mesh representation, although the techniques described herein may be modified to work with other mesh representations. The method generally includes identifying normal vectors for all or a region of the 3D model (mesh) and comparing these normal vectors to normals derived for equivalent areas estimated from 2D reference images. The 2D reference images may be while-light images of equivalent regions of the 3D model. The 2D reference images may be the same image use to generate the 3D model or may be taken at the same time as the images used to generate the 3D model, e.g., taken with an intraoral scanner.

The corresponding 2D images may be identified as described above, including by identifying regions or sub-regions of the 3D model (e.g., dividing the 3D model into sub-regions) and identifying 2D images from a set of 2D images of the subject's dentition that show the same region or sub-region. Once one or more 2D reference images are identified, a plurality of normal vectors may be generated from the 2D reference image. In some examples, normal may be provided for each pixel of 2D reference image. In some cases the 2D reference image may be provided to a trained machine learning agent (e.g., neural network) that identifies normals for sub-regions (e.g., pixels or groups of pixels) from the 2D image that can then be compared to the normals of the corresponding region of the 3D digital model, such as the 3D mesh for each model. The 3D mesh model is a manifold; for triangular meshes, the manifold includes faces that have three fewer edges. For each triangle there are adjacent edges that share two points. The normal map generated from the one or more 2D reference images may be compared to the surface normals from the corresponding region of the 3D mesh model and the edge/points (vertices) of the 3D mesh model may be adjusted based on the comparison. For example, the vertices of the corresponding region of the 3D model may be adjusted in order to maximize the best match between the normals for each triangle and the normals from the 2D reference image(s).

This optimization may be performed quickly and efficiently using a sparse linear equation. This technique, when used to correct 3D surfaces by comparing normals, may be considered a global technique because it quickly and efficiently resolves disagreements between neighboring regions that may otherwise result in discontinuities.

Although the methods and apparatuses described herein may refer to surface of the 3D surface model, these surfaces may refer to external surfaces only, or may refer to both external and internal surface, particularly for 2D images and corresponding 3D digital models in which one or more penetrating wavelengths have been used. For example, a 3D model may be a surface model, or it may include internal structures, using a near-infrared (NIR) wavelength(s). In some cases the digital model may be a volumetric digital model. In some cases the 3D digital model may include surface information, based on visible light (e.g., white light) and/or may include internal information from a penetrative scan (e.g., a near-infrared scan) of the subject's oral cavity.

For example, described herein are methods comprising: accessing a three-dimensional (3D) digital mesh model of a subject's dentition; accessing one or more two-dimensional (2D) reference images corresponding to at least a region of the 3D digital mesh model; generating a surface normal map comprising target normals from the one or more 2D reference images; computing surface normals for corresponding regions of the 3D digital mesh model; comparing the surface normals from the 3D digital mesh model and the target normals from the surface normal map to determine a displacement of vertices of the 3D digital mesh to minimize the differences between the surface normals from the 3D digital mesh model and the target normals from the surface normal map; and modifying the 3D digital mesh model using the determined displacement of vertices.

In any of these methods, comparing the surface normals and the target normals may comprise solving a sparse linear equation system to optimize displacement of vertices of the 3D digital mesh that minimizes a cost function representing a difference between the surface normals from the 3D digital mesh model and the target normals from the surface normal map. The 3D digital mesh model may comprise a triangular mesh forming a manifold. The surface normal map may be generated using a trained machine learning model configured to estimate normals from the 2D reference images. In any of these methods, displacement of vertices may be constrained by shared vertices of adjacent faces in the mesh. The cost function may include a regularization term based on vertex area and a weight term based on cotangent Laplacian. The direction of displacement for each vertex may be defined along a vertex normal or along a ray from a virtual camera to the vertex.

Any of these methods may include dividing the 3D digital mesh model into a plurality of sub-regions and applying the method iteratively to each sub-region.

The 2D reference images may be obtained concurrently with or as part of an intraoral scan used to generate the 3D digital mesh model. The 3D digital mesh model may include both external and internal surfaces derived from visible and near-infrared imaging modalities.

Any of these methods may include applying boundary conditions to prevent unrealistic stretching or distortion of the 3D digital mesh model. The output of the modified 3D digital mesh model may be used to fabricate a dental appliance.

For example, a method may include: accessing a three-dimensional (3D) digital mesh model of a subject's dentition; accessing one or more two-dimensional (2D) reference images corresponding to at least a region of the 3D digital mesh model; generating a surface normal map comprising target normals from the one or more 2D reference images; computing surface normals for corresponding regions of the 3D digital mesh model; determining a displacement of vertices of the 3D digital mesh that minimizes a cost function including a difference between the surface normals from the 3D digital mesh model and the target normals from the surface normal map; modifying the 3D digital mesh model using the determined displacement of vertices; and outputting the modified 3D digital mesh model.

Also described herein are apparatuses (e.g., systems) for performing any of these methods. For example, a system may include: an intraoral scanner configured to generate an initial three-dimensional (3D) digital mesh model of a subject's dentition; a processing unit comprising a memory storing computer-program instructions, that, when executed by the one or more processors, perform a computer-implemented method comprising: accessing the 3D digital mesh model of the subject's dentition; accessing one or more two-dimensional (2D) reference images corresponding to at least a region of the 3D digital mesh model; generating a surface normal map comprising target normals from the one or more 2D reference images; computing surface normals for corresponding regions of the 3D digital mesh model; comparing the surface normals from the 3D digital mesh model and the target normals from the surface normal map to determine a displacement of vertices of the 3D digital mesh to minimize the differences between the surface normals from the 3D digital mesh model and the target normals from the surface normal map; and modifying the 3D digital mesh model using the determined displacement of vertices.

The system may be configured to perform any of the methods described above. For example, comparing the surface normals and the target normals may comprise solving a sparse linear equation system to optimize displacement of vertices of the 3D digital mesh that minimizes a cost function representing a difference between the surface normals from the 3D digital mesh model and the target normals from the surface normal map.

Also described herein are methods using depth maps. These methods may include: dividing a three-dimensional (3D) digital model of a subject's dentition into a plurality of sub-regions; correcting the 3D digital model of the subject's dentition by, for one or more of the plurality of sub-regions: identifying a two-dimensional (2D) reference image from a plurality of 2D images of the subject's dentition; generating a depth map from the 2D reference image that is scaled to the 3D digital model of the subject's dentition; and modifying the 3D digital model by adjusting the surface of the 3D digital model using the scaled depth map; and outputting the modified 3D digital model.

Any of these methods may include determining areas of the 3D digital model to modify, wherein correcting the 3D digital model of the subject's dentition comprises correcting the sub-regions corresponding to the determined areas of the 3D digital model. Determining areas of the 3D digital model to modify may comprise identifying one or more holes in the 3D digital model. The 3D digital model may be generated from an intraoral scan. In any of these methods, identifying the two-dimensional (2D) reference image from the plurality of 2D images of the subject's dentition comprises selecting the 2D reference image from one of the plurality of 2D images having a maximum pixel area corresponding to the sub-region. The plurality of 2D images of the subject's dentition may be taken at the same time as the 3D digital model. The 2D reference image may be a white light image.

In any of these methods identifying the 2D reference image from the plurality of 2D image of the subject's dentition may comprise selecting the 2D reference image from one of the plurality of 2D images having a minimum camera angle between a portion of the 2D reference image corresponding to the sub-region. Generating the depth map that is scaled to the 3D digital model of the subject's dentition may comprise using a trained machine learning agent to generate the depth map. The trained machine learning agent may be trained using a diffusion model. Generating the depth map that is scaled to the 3D digital model may comprise: generating a normals map from the 2D reference image and scaling the depth map to the 3D digital model using the normals map. Generating the normals map may comprise dividing the 2D reference image into a plurality of partial images having opening camera angles of 30 degrees or less and transforming the partial images using homography to normalize the angle difference and the normals to form the normals map.

In any of these methods, modifying the 3D digital model by adjusting the surface of the 3D digital model using the scaled depth map may comprise projecting the depth map onto the 3D digital model. Outputting the modified 3D digital model may comprise displaying the modified 3D digital model.

Any of these methods may include manufacturing a dental appliance using the modified 3D digital model.

For example, a method may include: determining areas of a three-dimensional (3D) digital model to modify; dividing at least the areas of the 3D digital model of a subject's dentition to be modified into a plurality of sub-regions; correcting the 3D digital model of the subject's dentition by, for each of the plurality of sub-regions: identifying a two-dimensional (2D) reference image from a plurality of 2D images of the subject's dentition wherein the plurality of 2D images of the subject's dentition are taken at the same time as the 3D digital model; generating a depth map from the 2D reference image that is scaled to the 3D digital model of the subject's dentition by: generating a normals map from the 2D reference image and scaling the depth map to the 3D digital model using the normals map; and modifying the 3D digital model by adjusting the surface of the 3D digital model using the scaled depth map; and outputting the modified 3D digital model.

Also described herein are systems for performing these methods (e.g., using a depth map) that may include: an intraoral scanner configured to generate an initial three-dimensional (3D) digital surface model of a subject's dentition; a processing unit comprising a memory storing computer-program instructions, that, when executed by the one or more processors, perform a computer-implemented method comprising: dividing a three-dimensional (3D) digital model of a subject's dentition into a plurality of sub-regions; correcting the 3D digital model of the subject's dentition by, for each of the plurality of sub-regions: identifying a two-dimensional (2D) reference image from a plurality of 2D images of the subject's dentition; generating a depth map from the 2D reference image that is scaled to the 3D digital model of the subject's dentition; and modifying the 3D digital model by adjusting the surface of the 3D digital model using the scaled depth map; and outputting the modified 3D digital model.

For example, a system may include: an intraoral scanner configured to generate an initial three-dimensional (3D) digital surface model of the subject's dentition; a processing unit comprising a memory storing computer-program instructions, that, when executed by the one or more processors, perform a computer-implemented method comprising: determining areas of a three-dimensional (3D) digital model to modify; dividing at least the areas of the 3D digital model of a subject's dentition to be modified into a plurality of sub-regions; correcting the 3D digital model of the subject's dentition by, for each of the plurality of sub-regions: identifying a two-dimensional (2D) reference image from a plurality of 2D images of the subject's dentition wherein the plurality of 2D images of the subject's dentition are taken at the same time as the 3D digital model; generating a depth map from the 2D reference image that is scaled to the 3D digital model of the subject's dentition by: generating a normals map from the 2D reference image and scaling the depth map to the 3D digital model using the normals map; and modifying the 3D digital model by adjusting the surface of the 3D digital model using the scaled depth map; and outputting the modified 3D digital model.

In general, also described herein are computer-readable storage medium comprising instructions which, when executed by a computer, cause the computer to carry out any of the methods described herein.

All of the methods and apparatuses described herein, in any combination, are herein contemplated and can be used to achieve the benefits as described herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

A better understanding of the features and advantages of the methods and apparatuses described herein will be obtained by reference to the following detailed description that sets forth illustrative embodiments, and the accompanying drawings of which:

FIG. 1A schematically illustrates an example of a method of modifying a 3D digital model based on one or more 2D images of the same objects included in the 3D digital model.

FIG. 1B schematically illustrates an example of a method of modifying a 3D digital model using depth maps derived from a corresponding 2D image.

FIG. 2A illustrates one example of an intraoral scanner that may be adapted for used as described herein.

FIG. 2B schematically illustrates an example of an intraoral scanner configured to generate a model of subject's teeth using any of the methods described herein.

FIG. 3A shows a first example of scanning a subject's dentition, illustrating a larger camera angle relative to an illuminated region of a tooth surface.

FIG. 3B shows a second example of scanning a subject's dentition, illustrating a smaller camera angle relative to an illuminated region of a tooth surface.

FIG. 3C illustrates one example of a scanning region that may result in a gap or opening of a 3D digital model based on the scanned region.

FIGS. 4A-4B illustrate an example of region of a subject's dentition scanned using an intraoral scanner. In FIG. 4A the scan missed the preparation margin line. In FIG. 4B the scan includes missing surface regions and distortions of the scanned body.

FIG. 5 schematically illustrates (in a one-dimensional example) correcting a missing surface region.

FIGS. 6A-6D illustrate estimation of normals (e.g. forming a normal map FIG. 7 shows a reconstructed surface with only the normals from FIGS. 6A-6D.

FIGS. 8A-8C illustrate examples of Z-normal estimation in digital scan. FIG. 8A shows a portion of a 3D digital model constructed from an intraoral scanner. FIG. 8B shows the scan of FIG. 8A with a hole introduced. FIG. 8C shows a reference 2D image of the same region as the hole.

FIGS. 9A-9B illustrate depth maps for the same region of a 3D digital model shown in FIGS. 8A-8C. FIG. 9A shows an image of the original 3D model. FIG. 9B shows the depth map of the image including the hole. FIG. 9C shows the depth map of the 2D reference image.

FIGS. 10A-10C illustrate reconstruction using a depth map and normals for a region of the 3D model shown. FIG. 10A shows the original depth map from the 3D surface model. FIG. 10B shows a depth map for a 2D reference image. FIG. 10C shows an image after combining the 2D reference image with the depth map of the 3D scan.

FIGS. 11A-11B illustrate an example of a technique for determining depth maps as described herein by dividing an image (e.g., of the 2D reference image) into image patches (e.g., a plurality of partial images) of opening angle of ˜30 deg. FIG. 11A shows circles representing the projected regions having a low opening angle (e.g., between the camera and the scanning surface) of the camera vector. FIG. 11B shows a transformed image of the plurality of partial images using homography.

FIGS. 12A-12I illustrate individual partial images in which each partial image (patch) is transformed using homography to set the image as if it was taken from the center of the patch.

FIGS. 13A-13B show an example of a 2D image (e.g., a white-light/color image) that is transformed as described in FIGS. 11A-11B and 12A-12I to divide the image into a plurality of partial images (patches).

FIGS. 14A-14B illustrate an example of a camera/ray component of normals generated from the full image (FIG. 14A) and of the plurality of partial images (FIG. 14B).

FIGS. 15A-15B illustrate an example of a mask (e.g., rigid mask) formed of the images shown in FIGS. 13A-13B and 14A-14B.

FIGS. 16 and 17 schematically illustrate examples of a computational scheme during run time (FIG. 16) and training time (FIG. 17), respectively.

FIGS. 18A-18C illustrate examples of a color image, max labeled image and rigid mask for this image.

FIGS. 19A-19B illustrate division of the 3D digital model of a subject's dentition into a plurality of sub-regions. FIG. 19A shows a lower dentition and FIG. 19B shows an upper dentition.

FIGS. 20A-20B illustrate an example of a region of a 3D digital model modified as described herein.

FIGS. 21A-21B illustrate an example of a region of a 3D digital model modified as described herein.

FIGS. 22A-22B schematically illustrate another example of a method of modifying a 3D digital model of a subject's dentition using a scaled depth map.

FIGS. 23A-23B illustrate an example of a region of a 3D digital model modified using the method shown in FIGS. 22A-22B.

FIG. 24 schematically illustrates an example of a method of modifying a 3D digital model using a normals map derived from a corresponding 2D image.

### DETAILED DESCRIPTION

Intraoral scanners may provide detailed, three-dimensional (3D) models of a subject's dentition. Described herein are methods and apparatuses that may improve the 3D model. In general, these methods may include modifying (e.g., filling in, improving, etc.) a 3D digital model of the patient that was by an intraoral scan, including 3D digital models that were generated from patterned illumination (e.g., structured light, patterned confocal imaging, etc.) using un-patterned illumination (e.g., uniform illumination) images or images converted to un-patterned illumination images.

In addition to 3D digital models, the methods and apparatuses described herein may use one or more 2D images that may be any appropriate wavelength(s), such as, but not limited to white-light (WL) illumination images, fluorescent images and/or near Infra-RED (NIR) illumination, which gives NIR images. Other types of illumination images may include ultraviolet (UV) or any other LED illumination without a mask or pattern.

An intraoral scanner may take images that may be used to create 3D surface models of the subject's dentition while scanning. For example, patterned illumination (e.g., structured light) images may be taken to generate 3D points while moving the camera(s), generating a 3D point cloud that may be combined, e.g., stitched together, to form the 3D model. The surface of the 3D model may be the meshing of the point cloud. Stitching may be used to estimate the position of the cameras/wand with respect to the surface.

An intraoral scanner may generally include one or more cameras that are rigidly connected in a scanning tool, such as a wand, that may be manually or automatically (e.g., robotically) scanned within the subject's mouth. If there are multiple cameras, the 3D relationship between the cameras may therefore be from calibration of the intraoral scanner. In general (as described in reference below), the intraoral scanner may interleave scanning of a 3D surface-building scan, such as a patterned illumination capturing scan, and scans of one or more un-patterned illumination images. The 3D surface-building scan such as the patterned illumination (e.g., structured light) scan may be used to generate the digital 3D model of the subject's dentition. For example, each patterned illumination scan capture may create a point cloud, and these point clouds may be stitched together to create a dense point cloud. The dense point cloud may then be transformed into a mesh, such as a triangular mesh, digital model. This process may result in a six degrees of freedom (DOF) transform that also represents the position and angle between the camera(s), e.g., in the wand, and the 3D surface model. Thus, for each of the un-patterned illumination images taken between individual patterned illumination image, the general position of the camera(s) relative to the 6 DOF transformation (e.g., the 3D model of the dentition) may be approximately known by interpolating the camera/wand position from the patterned illumination images taken before and after the un-patterned illumination image. In cases where there are multiple cameras, the cameras may take the images simultaneously, providing multiple, different, viewpoints, corresponding to each of the n cameras. Thus, the position of the scanning tool, e.g., wand, in which the n cameras have a fixed relationship, may be used to determine where all the n cameras were relative to the 3D model based on the 6 degree of freedom transformation.

Described herein are methods and apparatuses (e.g., systems and devices, including software, hardware and/or firmware) for modifying a 3D digital model of a subject's dentition using one or more two-dimensional (2D) image. These methods and apparatuses may use one or more properties derived from one or more 2D images corresponding to a region or regions of the object(s) shown in the 3D digital model. In particular, these methods and apparatuses may generate a mapping of values (e.g., target values) for one or more properties from the 2D image, determine values (e.g., estimated values) for the same one or more properties for corresponding regions of the 3D model, and adjusting the surface of the 3D digital model to minimize the difference between the target values and the estimated values for corresponding regions. The surface of the 3D digital model may be adjusted by optimizing a cost function, e.g., using sparse linear equations that describe the cost function. In some cases the one or more properties may correspond to a first-order and/or second-order fundamental form for the object(s) in the 3D model and corresponding object(s) in the 2D image(s). For example, the one or more properties may be one or more of: depth (e.g., a depth map), normals (e.g., a surface normal map), mean curvature (e.g., a curvature map), etc. The examples described herein include both the use of normals (e.g., second-order fundamental forms) as well as depth (e.g., depth maps, which may be derived from the second order fundamental forms). Curvature, e.g., mean curvature, may be a second-order fundamental form that may be similarly used. In some cases combinations of properties, such as depth maps and normals may be used.

For example, in some variations the method described herein may use one or more 2D images from which a depth map may be generated in order to modify a 3D surface model. The 2D image may match the region of the 3D model to be modified (e.g., corrected), and the depth map generated from the 2D image may be scaled with the 3D digital model. This scaled depth map may then be used to adjust the surface of the 3D model. The resulting modified 3D surface model may be output, e.g., by being saved, transmitted, displayed, etc. This process may be performed across multiple regions of the 3D digital model and may be performed sequentially (e.g., in series) or in parallel, or some combination of series and parallel. In some cases, overlapping regions may be modified. In some cases multiple 2D images may be used for the same region of the 3D model.

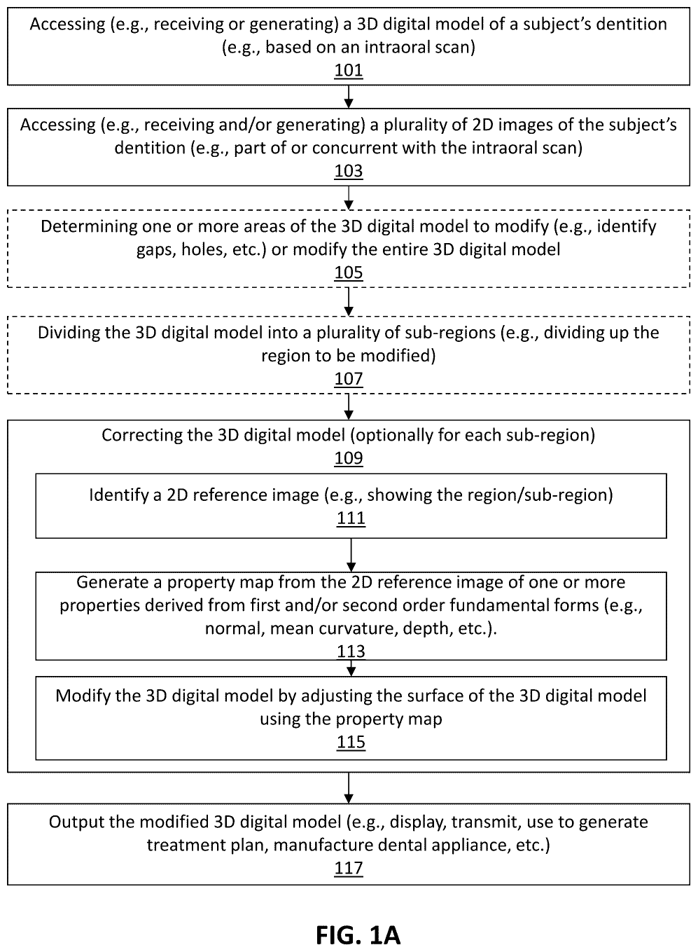

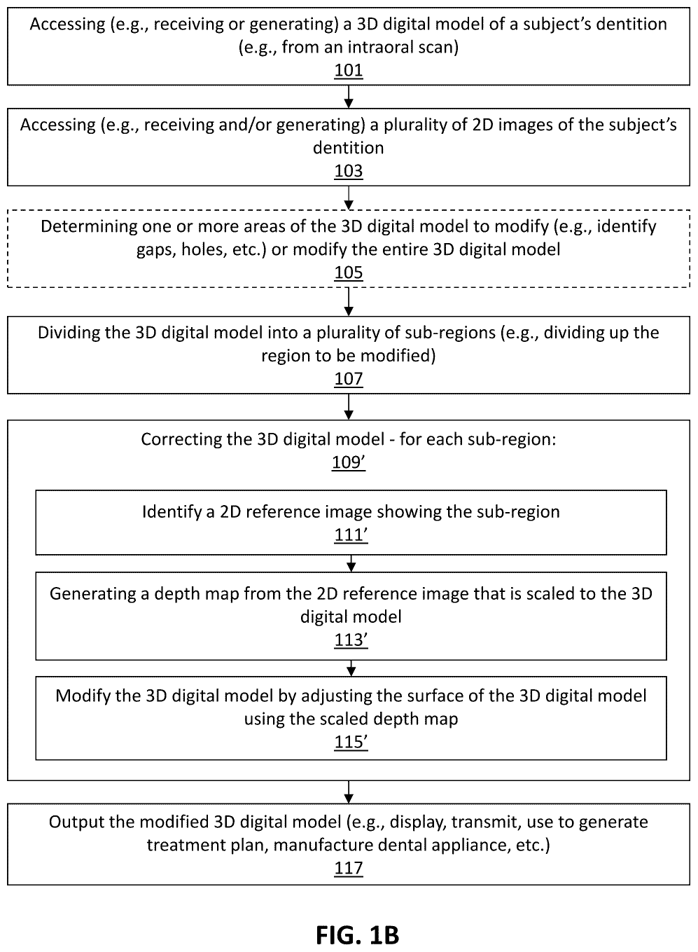

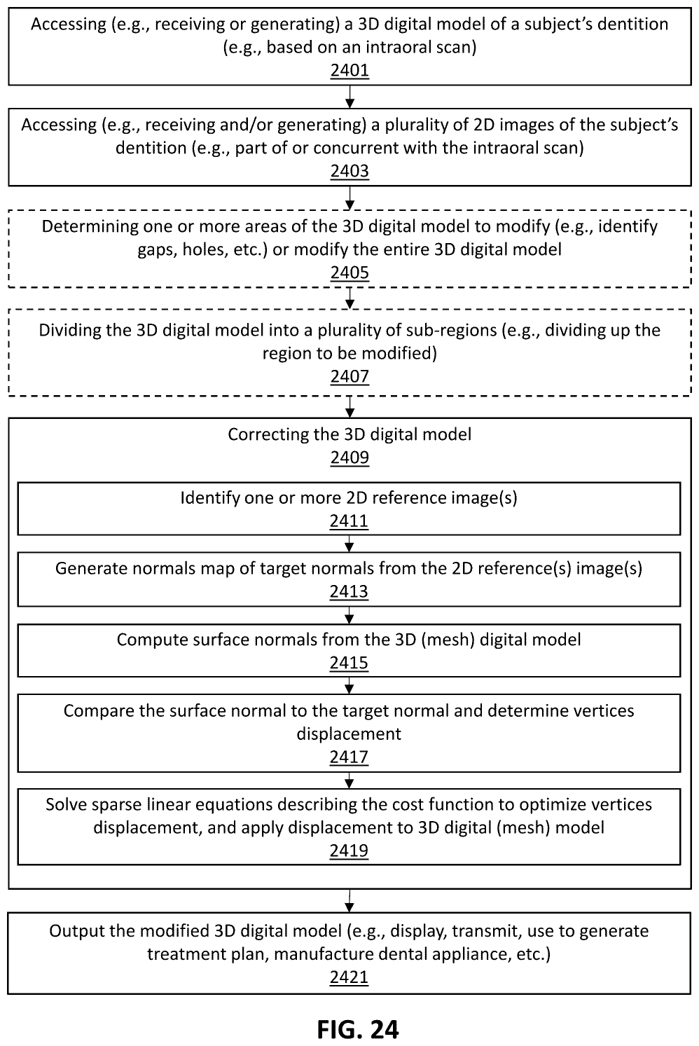

FIG. 1A schematically illustrates a general method of modifying (e.g., improving, correcting, etc.) a 3D model of a subject's dentition using one or more 2D images of the subject's dentition. FIG. 1B schematically illustrates one example of a method as described herein in which depth maps derived from the 2D image are used. FIG. 24 (discussed in greater detail below) illustrates another example in which surface normals are used, without requiring depth mapping. For example, in both FIGS. 1A and 1B (and also in FIG. 24), the method may optionally include accessing (e.g., receiving or generating) a 3D digital model of a subject's dentition 101; in some cases the 3D digital model may be from an intraoral scan. Optionally, the method may include accessing (e.g., receiving and/or generating) a plurality of 2D images of the subject's dentition 103. In some cases the 2D images may be taken before, during or after the scan from which the 3D model is being generated. For example, the 2D images may be taken at the same time as the scan from which the 3D model is being generated, such as an intraoral scan.

Any of these methods may optionally include determining one or more areas of the 3D digital model to modify (e.g., identify gaps, holes, etc.) or modify the entire 3D digital model 105. Thus, the methods or apparatus may home in on a particular region or regions to modify. In some cases the areas may correspond to areas in particular need of repair or correction, while in some cases the method or apparatus may be set to always attempt to modify/correct one or more regions (e.g., interproximal regions, teeth regions, particular subsets of teeth, etc.).

In some cases, the methods described herein may include dividing the 3D digital model into a plurality of sub-regions (e.g., dividing up the region to be modified). Sub-regions may be based on regions of the teeth, gingiva, etc. 107. Regions may be based on the regions for which 2D images are available; for example the size of the regions may be based on the size of the one or more 2D images used for the method.

In the general case, the 3D digital model may be corrected 109 either in its entirety or partially, e.g., optionally for each sub-region if identified above. For example, one or more 2D reference images may be identified 111. The 2D images may be selected to correspond to all or a portion/region (e.g., sub-region) of the object(s) in the 3D digital model, such as the teeth, gingiva, palate, etc. The method (or apparatus configured to perform the method) may generate a property map for the 2D reference image for one or more properties 113. These properties may be derived from the first and/or second order fundamental forms; for example, the properties may be normals (e.g., surface normals), mean curvature and/or depth (e.g., depth maps). The 3D digital model may then be modified using the property map by adjusting the surface of the 3D digital model (e.g., mesh model, such as a triangular mesh model) so that the properties when measured from the 3D model better conform to the properties mapping 115.

For example, the property and corresponding property map may be a depth map, as mentioned above. Thus, in some cases, as illustrated in FIG. 1B, the 3D digital model may be corrected for each sub-region 109′, which may include identifying a 2D reference image showing the sub-region 111′, generating a depth map from the 2D reference image that is scaled to the 3D digital model 113′, and modifying the 3D digital model by adjusting the surface of the 3D digital model using the scaled depth map 115′. Each of these steps is described in greater detail below.

Finally, these methods may include outputting the modified 3D digital model (e.g., display, transmit, use to generate treatment plan, manufacture dental appliance, etc.) 117. In some cases the output may be used for performing or planning a dental or orthodontic treatment and/or for forming one or more dental appliances to perform such dental or orthodontic treatments.

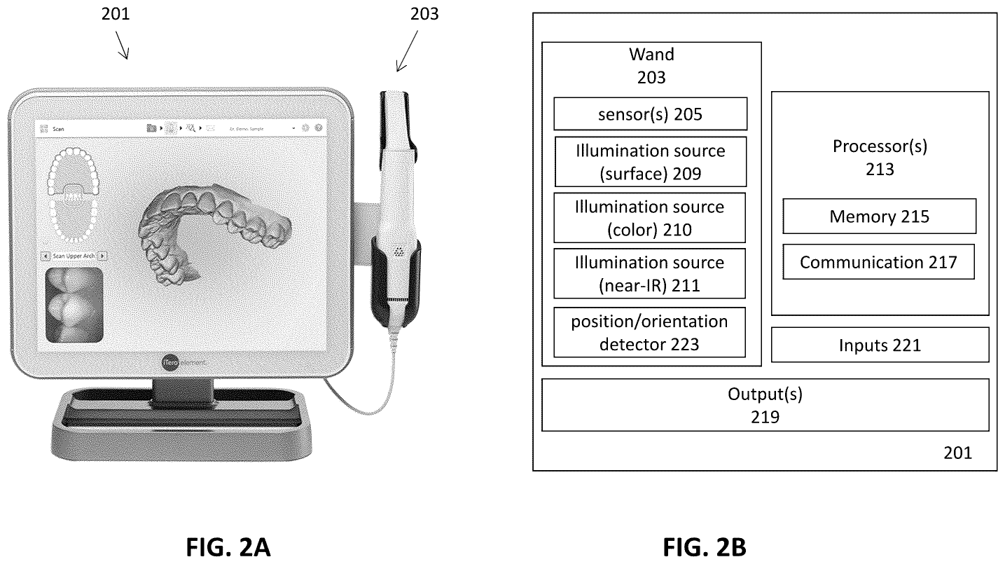

FIGS. 2A-2B illustrate one example of an apparatus (e.g., a system) that may be configured to perform the methods described herein. In some examples, the system may include or be integrated into (e.g., part of) an intraoral scanner 101. The intraoral scanner may be configured to generate digital 3D model of the subject's dentition. The system 201 may include a scanning tool, shown as a wand 203 in this example. As shown schematically in FIG. 2B, an exemplary system including an intraoral scanner may include a wand 203 that can be hand-held by an operator (e.g., dentist, dental hygienist, technician, etc.) and moved over a subject's tooth or teeth to scan. The wand may include one or more sensors 205 (e.g., cameras such as CMOS, CCDs, detectors, etc.) and one or more light sources 209, 210, 211. In FIG. 2B, three light sources are shown: a first light source 209 configured to emit light in a first spectral range for detection of surface features (e.g., visible light, monochromatic visible light, etc.; this light does not have to be visible light), a second color light source (e.g., white light between 400-700 nm, e.g., approximately 400-600 nm), and a third light source 111 configured to emit light in a second spectral range for detection of internal features within the tooth (e.g., by trans-illumination, small-angle penetration imaging, laser florescence, etc., which may generically be referred to as penetration imaging, e.g., in the near-IR). Although separate illumination sources are shown in FIG. 2B, in some variations a selectable light source may be used. The light source may be any appropriate light source, including LED, fiber optic, etc. The wand 203 may include one or more controls (buttons, switching, dials, touchscreens, etc.) to aid in control (e.g., turning the wand on/of, etc.); alternatively or additionally, one or more controls, not shown, may be present on other parts of the intraoral scanner, such as a foot petal, keyboard, console, touchscreen, etc.

The light source may be matched to the mode being detected. For example, any of these apparatuses may include a visible light source or other (including non-visible) light source for surface detection (e.g., at or around 680 nm, or other appropriate wavelengths). A color light source, typically a visible light source (e.g., “white light” source of light) for color imaging may also be included. In addition a penetrating light source for penetration imaging (e.g., infrared, such as specifically near infrared light source) may be included as well.

The apparatus 201 may also include one or more processors, including linked processors or remote processors, for both controlling the wand 203 operation, including coordinating the scanning and in reviewing and processing the scanning and generation of the 3D model of the dentition. As shown in FIG. 2B the one or more processors 213 may include or may be coupled with a memory 215 for storing scanned data (surface data, internal feature data, etc.). Communications circuitry 217, including wireless or wired communications circuitry may also be included for communicating with components of the system (including the wand) or external components, including external processors. For example the system may be configured to send and receive scans or 3D models. One or more additional outputs 219 may also be included for outputting or presenting information, including display screens, printers, etc. As mentioned, inputs 221 (buttons, touchscreens, etc.) may be included and the apparatus may allow or request user input for controlling scanning and other operations. The apparatus may also include communication circuitry for controlling communication with one or more external processors. An output (e.g., screen, display, etc.) may be provided.

As mentioned above, the intraoral scanners providing the scan image and/or 3D model of the dentition may be configured to operate by interleaving and cycling between surface-model generation scans (e.g., patterned illumination/structured light images) and un-patterned illumination images (e.g., white light images, near-IR images, etc.).

Intraoral scanning may have issues with scanning surfaces as the light projected from the scanner in a ray may miss regions that are in shadow, e.g., may be obscured by projections or protrusions, and/or may be in recesses on the surface. This is true with confocal and with structured light, particularly when using visible (e.g., white) light. Specifically, this may happen in regions containing “dips,” since the visible light typically request the light (e.g., laser light) to hit the surface, and the cameras (e.g., at least two cameras) to see that light-surface intersection, and dips may create regions where it is hard to position the scanner in such way that the scanner can successfully predict the structure of the teeth.

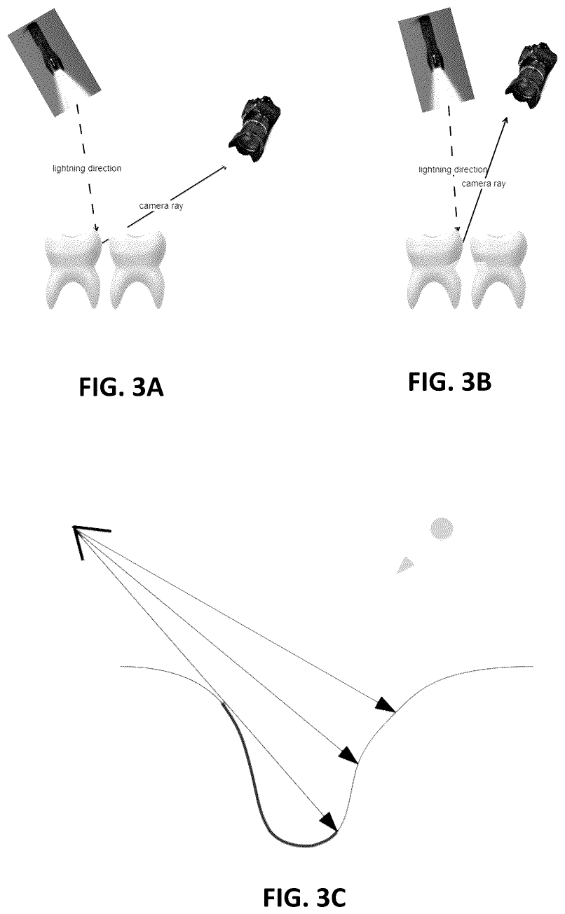

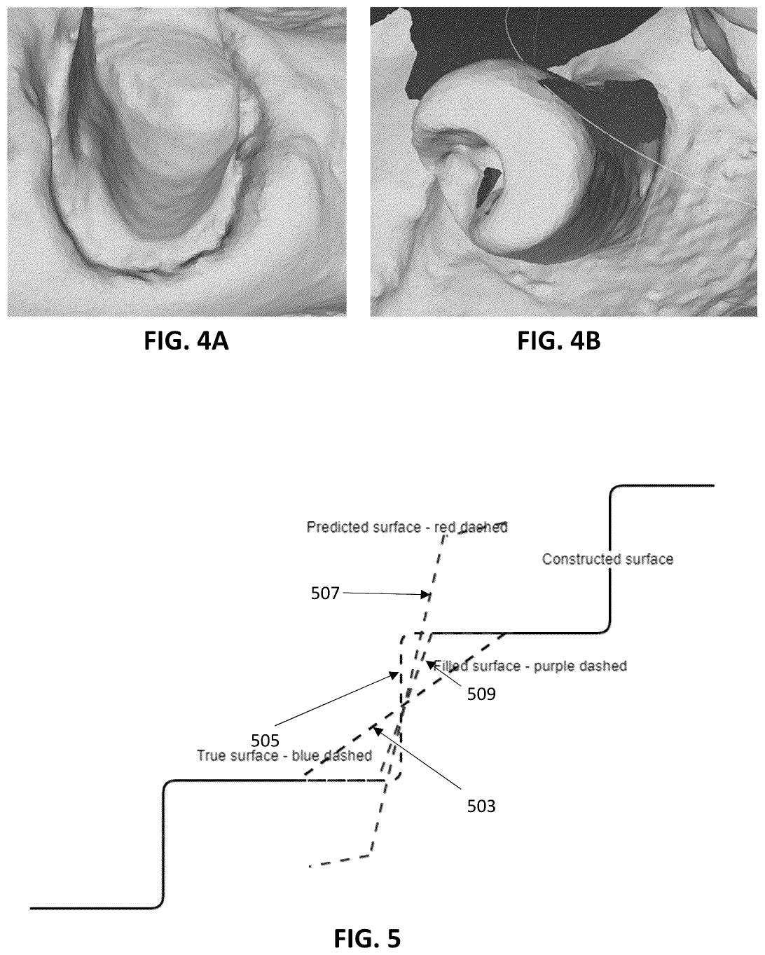

This issue is illustrated in FIGS. 3A-3C. In FIG. 3D, when structured light is used, it may be difficult to position the scanner relative to the tooth surface to capture deeper regions. Thus, some areas within the surface may be hard to predict with structured light. When scanning the teeth, regions that may be difficult to reach include the prep margin line and concealed parts of scan bodies (e.g., between the teeth). For example, FIGS. 4A and 4B shows scans taken from a patient that will be receiving a dental restorative. In FIG. 4A the tooth image does not show the prep margin line, e.g., the boundary that separates the prepared tooth structure from the unprepared tooth structure, which is the contact area between the tooth and a dental restoration. In FIG. 4B, the tooth has a region of missing surface and resulting distortion. This may result because of the high angle between the light source (e.g., the projector, e.g., of the spot for the structure light) and the returned ray to the cameras, preventing the captured surface from being seen by multiple cameras, as in such cases it may be desirable to detect a ray by more than one camera). This is illustrated in FIGS. 3A-3B as well.

To overcome this difficulty the methods and apparatuses described herein may reconstruct part of the surface with the aid of at least one color (e.g., visible or white light) image. This may be used to fill holes on the original reconstructed surface. Holes may be filled using depth maps by predicting the normals from the at least one color image and then integrating the normals to produce the relative correction the original surface.

FIG. 5 schematically illustrates a simplified version of this method in one dimension. In this example, a surface that may cause difficulties when properly capturing part of the surface (see one dimensional example below) is shown. The ‘true surface’ is shown by the dashed line 505 mimicking the same step shape as the properly imaged regions above and below. In some cases the gap region (shown by the dashed lines) may be filled using a hole-filling technique that is similar to a soap bubble, resulting in a constructed surface 503.

From a single image or normals image the method and apparatuses described herein can reconstruct depth map up to scale that may predict something like the predicted surface 507. Further, a correction the original depth map may be made so that the resulting depth map us of the same scale, so that the final correction fits the shape better, as shown by the filled surface 509.

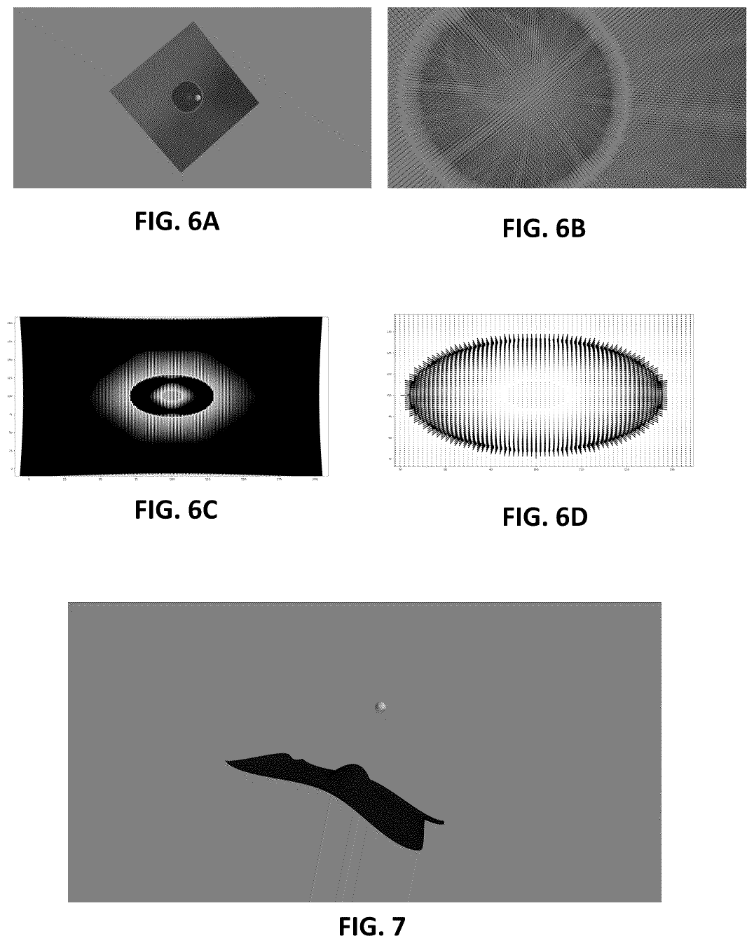

Thus, the methods (and apparatuses for performing them) described herein may integrate from normal of the image. This is schematically illustrated in FIGS. 6A-6D. Using a depth map and knowing the depths relative to one point in space (e.g., a pinhole) a derived relationship between normals in ray coordinate system and derivatives of depth map may be used: n\hat{ }=λ(∂ log d/∂θ, ∂ log d/∂ϕ, 1). Theta and phi are angular coordinates perpendicular to the ray and d is the depth (assuming pinhole camera) and lambda is proportion factor. This may be derived from the formula for gradient in spherical coordinates:

$$\frac{\partial f}{\partial r} \hat{r} + \frac{1}{r} \frac{\partial f}{\partial θ} \hat{θ} + \frac{1}{r sin θ} \frac{\partial f}{\partial φ} \hat{φ}$$

The ray coordinate system may be defined by ray direction, the direction perpendicular to the ray which its projection to the screen will give the direction of i, and the third direction is the leftover direction. This may also define the rotation between camera coordinate system and ray coordinate system.

FIG. 6A shows a normal map on the screen (the dot indicates the pinhole). FIG. 6B shows a zoomed-in normal map on the screen/image. Given the normal, the depth map gradient may be deduced relative to the pixel coordinates in the image. The gradient may be expressed in terms of position (e.g., row, column) by a Laplacian of log \hat{d} that equals the divergence of the gradient of log d, where d is the depth. However in some examples it may be beneficial to solve this using Newman boundary conditions (e.g., using cosine transform) which may yield zero harmonics distortions. In areas outside of the hole the correction to the depth is 1 (log of it equals 0) and all of its derivatives. FIG. 7 graphically illustrates this technique with respect to the example shown in FIGS. 6A-6D.

Thus, the depth may be determined for these regions by applying the Newmann boundary conditions to the Poisson equation on a rectangular domain. Although limited to discrete sampling (e.g., in pixels), a finite element with bilinear basis functions may simplify the Laplacian, e.g.,

$$λ {\vec{∇}}^{2} ϕ = 3 {6}_{i , j} - {8}_{i \pm 1 , j} - {8}_{i , j \pm 1} - {ϕ}_{i \pm 1 , j \pm 1}$$

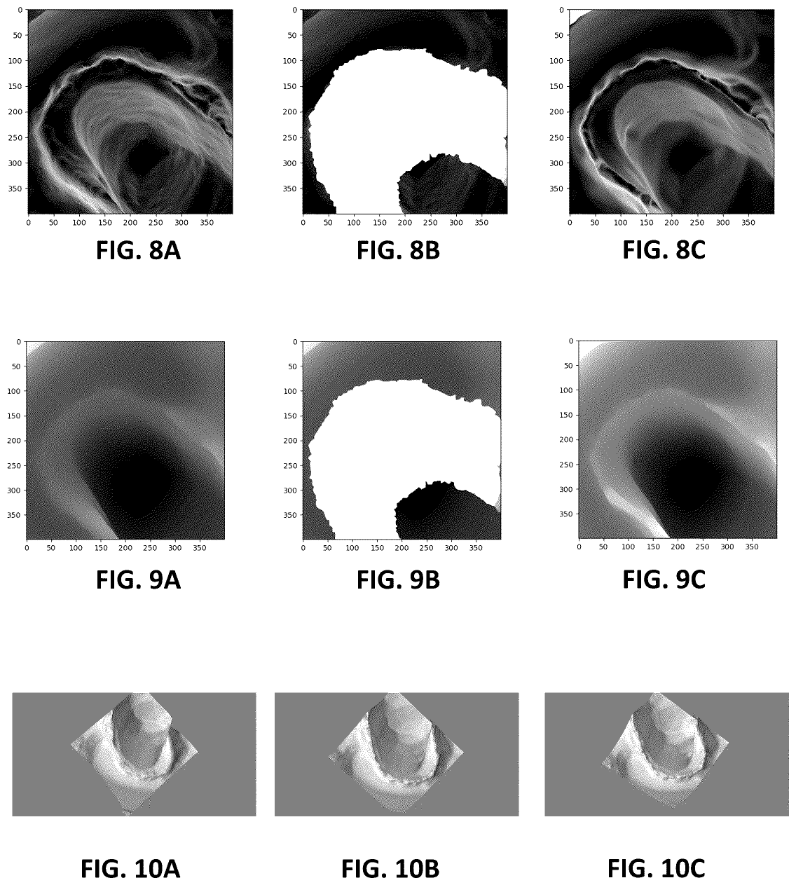

The discrete cosine transformation may then be applied on this equation and the results applied to solve for the depth map. FIGS. 8A-8C and 9A-9C illustrate this technique. In FIG. 8A an original region of an intraoral scan is shown, and FIG. 8B shows the scan of FIG. 8A with a hole introduced (white region). FIG. 8C shows are reference image for these z-normal images. FIGS. 9A-9C show a depth map based on these. FIG. 9A shows the depth map for the original depth, FIG. 9B the depth map with the hole and FIG. 9C the reference image. After reconstructing via the normal the surfaces shown for each of these is illustrated in FIGS. 10A-10C. FIG. 10A shows the surface with the original depth (from the scan), FIG. 10B shows the reference depth map, and FIG. 10C shows the combined depth map.

When sampling small opening angles, the opening angle along the diagonal of an image may be ˜90 degrees. This may make the perspective distortion very prominent. When convolving the image with constant kernels, the angle difference of neighboring pixels may change by factor of ˜2 from image center to image corners. This may make it difficult or even impossible to derive geometric properties when using the original image in these situations. The methods and apparatuses described herein may address this issue by dividing the image into image patches each having opening angles of ˜30 deg. Each image patch may then be transformed using homography to set the image as if it was taken from the center of the patch. This makes the angle difference factor to be ˜1.02 between each patch center and patch corners. The normal may be transformed accordingly.

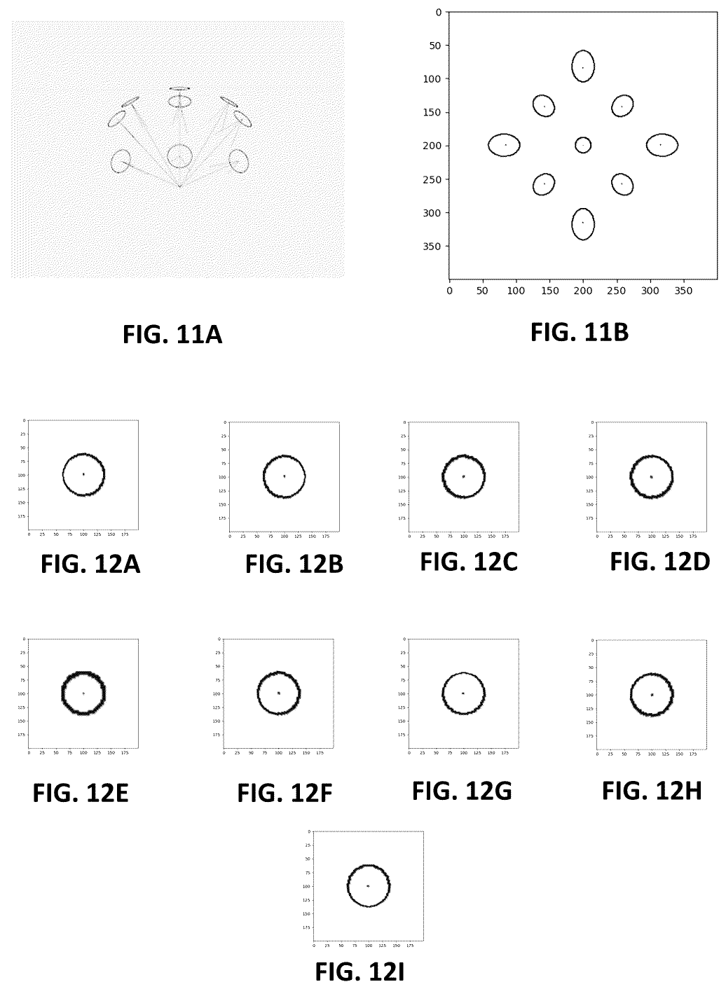

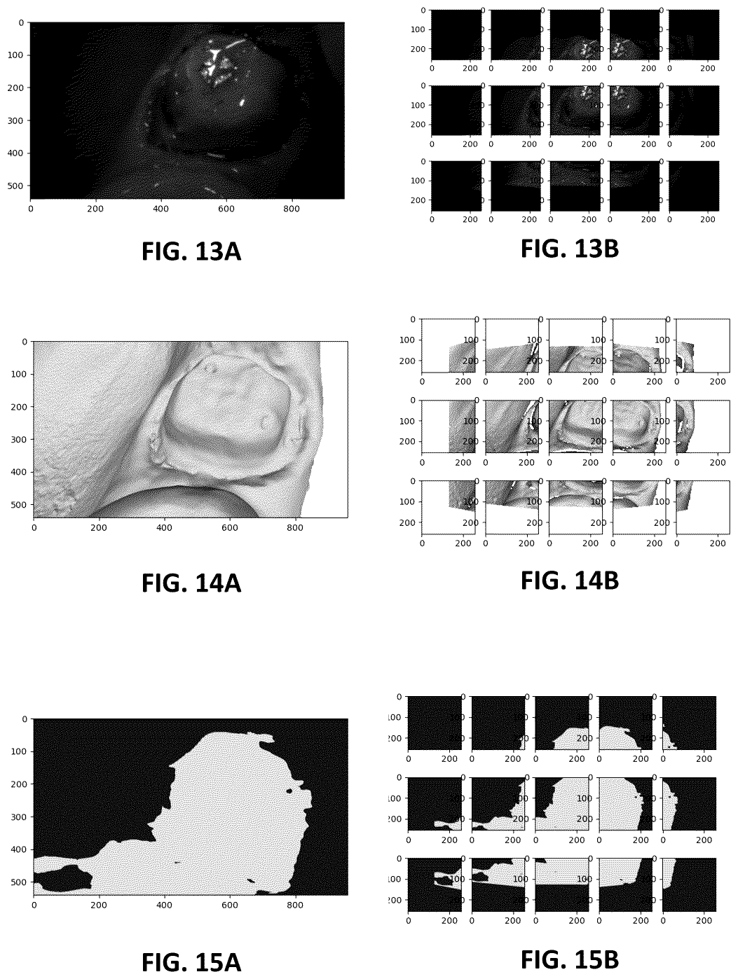

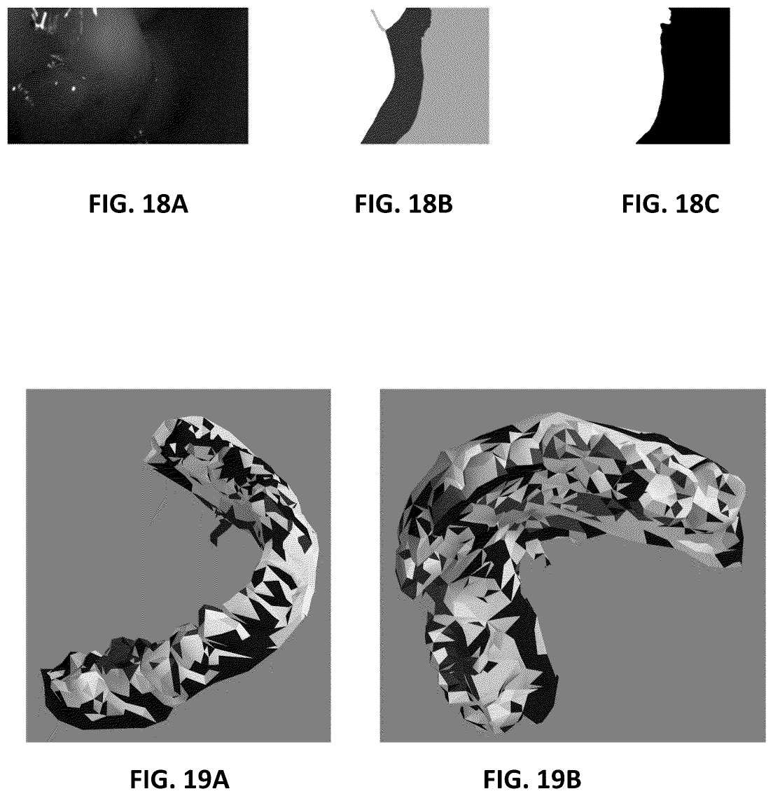

FIGS. 11A-11B and 12A-12I illustrate a simplified example of this technique, showing patches sampling on circles. In this example, each circle is sampled so that the center of the patch would be on the projection of the circle center. After patch sampling, each circle is imaged as a circle (and not an ellipse), due to the perspective deformation lifting. FIG. 11A shows the circles captured from the origin (e.g., in which the camara pinhole is positioned at the center). FIG. 11B shows the original image and FIGS. 12A-12I show the sampled patches. This technique is demonstrated on an example from an intraoral scan, shown in FIG. 13A. FIG. 13B shows the small opening angle sampling of this image. FIG. 14A shows the normal map for the same image (of FIG. 13A) and FIG. 14B shows the small opening angle sampling for this normal map. FIG. 15A shows a mask (e.g., rigid mask) applied to the image, and FIG. 15B shows the small opening angle sampling for the rigid mask. For example, FIGS. 18A-18C illustrate one example, showing a color image (FIG. 18A), max label image (FIG. 18B, including teeth, border, gums/soft tissue) and a rigid mask (FIG. 18C).

In some examples, these techniques for generating the depth map from the images as described above may be implemented as part of a neural network, such as, but not limited to, a convolutional neural network (e.g., unet). The input for the network may be the log depth derivative described above, of the initial surface, color image and label mask image. In some cases, this may be, for example, six channels of input. The output of the network may consist of the difference between the log depth derivative of the reference surface to the initial surface depth derivatives (e.g., two channels). In this example, the loss may be estimated as the sum over squares of the difference between the log depth derivative to the sum of the network output and the derivatives of the initial surface. The sum may be taken on rigid pixels and pixels were both norm of reference surface derivatives and initial surface derivatives is lower than a given threshold. A rigid mask may have a value of 1 for each pixel which is predicted to be imaging rigid such as teeth and hard gingiva up to a distance of 35 mm from the pinhole and a value of 0 for anything else.

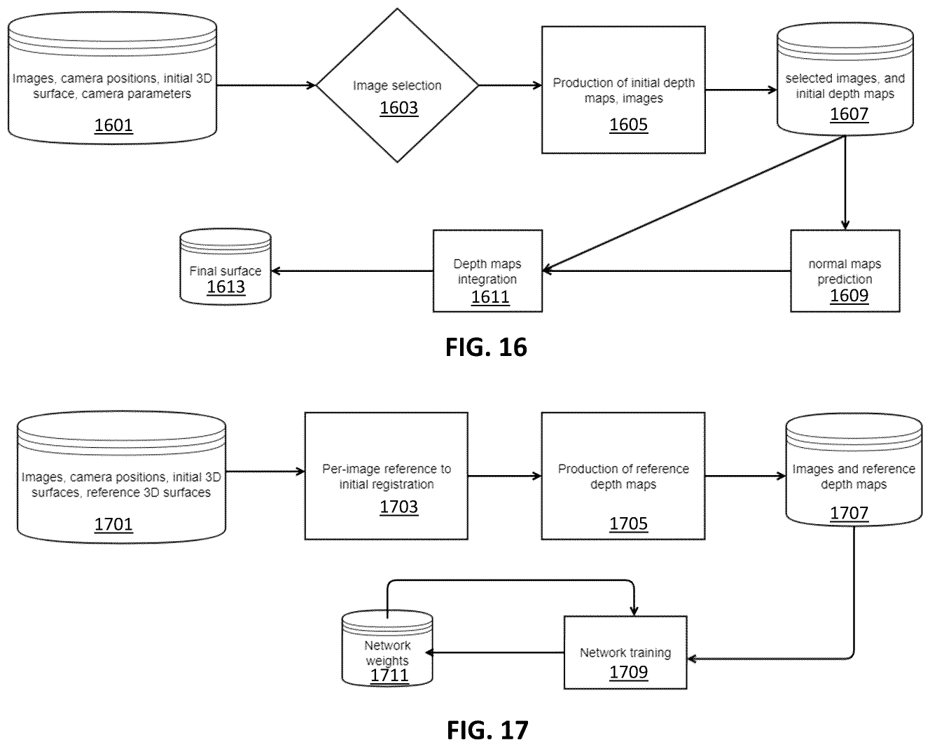

FIGS. 16 and 17 schematically illustrate examples of computational schemes that may be used. For example, as illustrated in FIG. 16, an image may be selected 1603 from a database 1601 or may be received directly from the imaging system (e.g., an intraoral scanner). Any of the methods and apparatuses described herein may form part of, or may be used in combination with, an intraoral scanning system.

The step of generating, selecting, accessing and/or receiving the image 1603 may include the image or images and may also include data on camera position(s) corresponding to the image(s), initial 3D surface information and/or camera parameters corresponding to the image(s).

The method shown in FIG. 16 may use the selected image (and any corresponding data) to produce an initial depth map for each of the image(s) 1605, as described above. This step may be iteratively performed, e.g., for multiple images, including multiple images of an intraoral scan corresponding to the image(s). These initial depth maps may be stored, along with the corresponding images, in a database (e.g., datastore 1607). From this data, the method may include or generate normal maps, which may be predicted for each of the images and/or depth maps 1609, and the normal maps may be integrated with the images (and in some cases the depth map) 1611, as described. These integrated depth maps may be used to generate a final surface, which may be displayed, stored and/or transmitted 1613. One or more machine learning agents may be used to perform any of these steps. For example, a machine learning agent may be used to generate the final surface, and/or to predict the normal maps and/or to generate the depth maps.

FIG. 17 illustrates an example of a training a network (e.g., a machine learning agent) that may be used. In this example a database of any of: reference images, camera positions, initial 3D surfaces and reference 3D surfaces may be used 1701 and accessed to perform per-image reference to initial registration 1703, as described above. This may be used to generate reference depth maps 1705, which may be stored, along with the images 1707 and passed for scoring and training by the network 1709, which may iteratively repeat these steps to generate weights for the machine learning agent as part of the training.

In general, a trained machine learning agent may be an artificial intelligence agent. In some cases the machine learning agent may be a deep learning agent. The trained machine learning agent may be trained neural network. Any appropriate type of neural network may be used, including generative neural networks. The neural network may be one or more of: perceptron, feed forward neural network, multilayer perceptron, convolutional neural network, radial basis functional neural network, recurrent neural network, long short-term memory (LSTM), sequence to sequence model, modular neural network, etc.

In practice the method and apparatus described herein divide a three-dimensional (3D) digital model of a subject's dentition into a plurality of sub-regions and may correct or adjust all or some of these sub-regions. For example, these methods (and apparatuses for performing them) may correct the 3D digital model of the subject's dentition by, for one or more of the plurality of sub-regions, identifying a two-dimensional (2D) reference image from a plurality of 2D images of the subject's dentition that includes a region of the dentition (e.g., tooth, gingiva, etc.) present in the sub-region. A depth map may then be generated for the 2D reference image. The 2D reference image and/or depth map may be scaled to the 3D digital model of the subject's dentition. Finally, the 3D digital model may then be modified by adjusting the surface of the 3D digital model using the scaled depth map. The modified 3D digital model may be output. The resulting modified 3D digital model may be significantly more accurate than the uncorrected 3D digital model and may be stored, transmitted and/or used in order to generate one or more dental appliances, e.g., for treating the subject's teeth.

Thus, in general, these methods may include selecting one or more 2D images (and associated camera positions and/or camera intrinsic parameters) and an initial 3D surface where the images correlate with region of the 3D surface. The 2D image may be taken before, during or after the 3D scan (e.g., intraoral scan) generating the 3D model. The 3D model from the intraoral scan may be improved using the 2D images, as mentioned above, particularly in regions that are difficult to fully visualize using the wand of the intraoral scanner. A subset of the images may be selected. This may be generally performed by producing initial normal maps that correspond to each of the 2D images; the normal maps may be generated by sampling the surface, as described above. For example, each pixel may have a normal for which the camera ray intersects the surface. The normal may be represented at this stage in camera coordinate system. The system may also produce a depth map for each image, as described above.

In cases these procedures may be simplified by segmentation of the 2D image(s), e.g. using a trained machine learning network (e.g., an MTD network). In some examples, each pixel may get the relevant label of that pixel. Each of the 2D images may be divided into regions based on the relative angle. For example, each of these 2D images may be divided into an almost square grid in the opening angle. For each grid point, the method may sample the image, initial normal map, and label map to an image for which the grid point is the image center (e.g., the closest point of screen to camera pinhole) and the opening angle is fixed (e.g., in some examples as approximately 30 degrees). The sampling may be performed by perspective warping. In some examples trained machine learning agent (e.g., neural network) may be used to predict the desired surface normals from this input. The system may sample back the surface normal from the network normals and may integrate the normals to get the final depth map. The system may also be constrained so that the final surface remains close at times to the initial surface in regions where it is known that the initial surface is fairly accurate. The final 3D surface may then be generated from the new depth maps.

As described above in reference to training of the machine learning agent, training may include receiving an image with camera positions, camera intrinsic parameters and initial 3D surface. Initial normal maps may be generated from the corresponding to each image by sampling the surface. Each pixel may get the normal for which the camera ray intersects the surface. The normal at this stage may be represented in the camera coordinate system. A segmentation image may be generated by the network. As mentioned, each pixel may get the relevant label of that pixel, and/or each pixel may be assigned a true/false value corresponding to the underlying tissue; for example, the pixel may have a true value if it is a rigid pixel, a false value if it is a moving tissue (e.g., ‘soft’) or a vacant pixel. The system may produce reference normal maps from a reference scanner. Each image may be divided to an almost square grid in the opening angle. For each grid point, the image may be sampled, an initial normal map made, and a label map made corresponding to an image for which the grid point is the image center (e.g., the closest point of screen to camera pinhole) and the opening angle may be fixed (e.g., typically 30 degrees). The sampling may be performed by perspective warping. A data set consisting of the regions having small opening angles may be prepared. The network may be trained with inputs of labels, images, and initial normals and the network output may be the difference of the desired normal to the initial normal. A loss may be calculated only on a rigid pixel for which we have a normal from the reference surface.

Any of these methods may include training and/or using a machine learning agent (e.g., neural net) that directly predicts depth maps. The trained machine learning agent may take as an input the initial depth map (e.g., sampling of the initial existing surface) and the color image for which the improved depth maps is being created and may output the new desired improved depth maps. The training data may include scanned surfaces for which a good model exists, either by accurately scanning these by reference scanner or by achieving digital surface upon which they were manufactured.

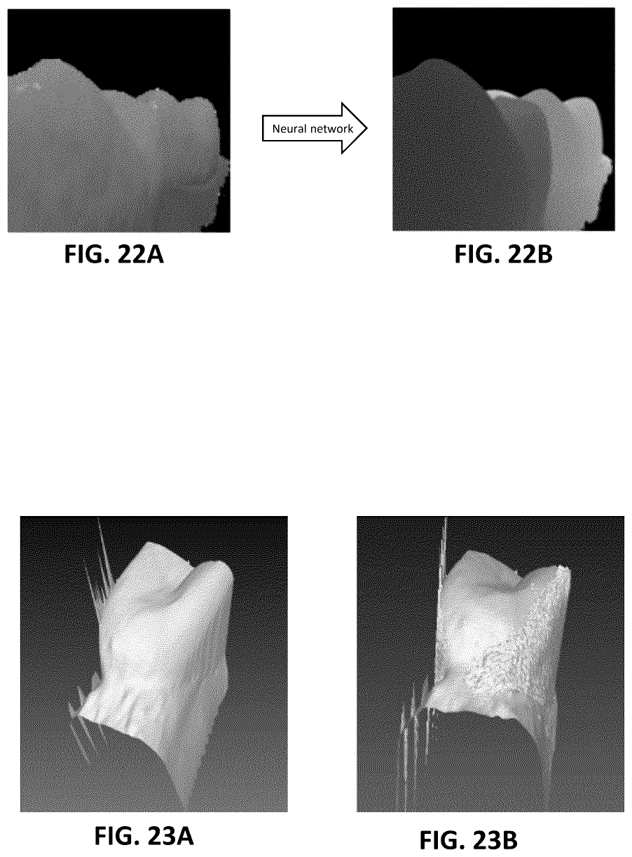

FIGS. 22A and 22B show another example in which the machine learning agent (e.g., neural network) was trained to receive a white light image as input and output an estimate of the depth. This allowed for the reconstruction to improve the mesh. In this example the machine learning agent was trained using a diffusion model, in which the network is trained to iteratively solve the problem of estimating the depth (rather than as a single step). After the depth estimation is determined, it may be projected back onto the 3D space, as shown graphically in FIGS. 23A-23B. A region of the tooth in the digital model (shown in FIG. 23A), may be masked and this portion reconstructed as described herein (shown in FIG. 23B).

As mentioned above, the all the partial depth maps may be combined to create a coherent surface which represents the entire jaw from the multiple images. However it may be particularly beneficial to select only some of the partial depth maps from the multiplicity of images; and in particular the partial depth maps which best represents the final surface. The accuracy of each area of the depth map may be mainly determined by geometric properties of the area and the camera, such as relative angle between the camera ray and surface normal, camera direction, etc. In order to operate on large enough areas of the surface and not on very small triangles our original mesh may be simplified. In some examples the apparats and/or system may target, e.g., ˜2000 triangles per jaw after simplification. Each triangle may be reconstructed from a single image. The single image corresponding to each of these sub-regions may be selected so that the projected area of the triangle in pixels squared is maximal. The area which is considered inside the image may have margins from left and right rows (e.g., 150 pixels of each side out of 960 pixels) and from up and down columns (e.g., 100 pixels out of 540). Any appropriate dimensions may be used.

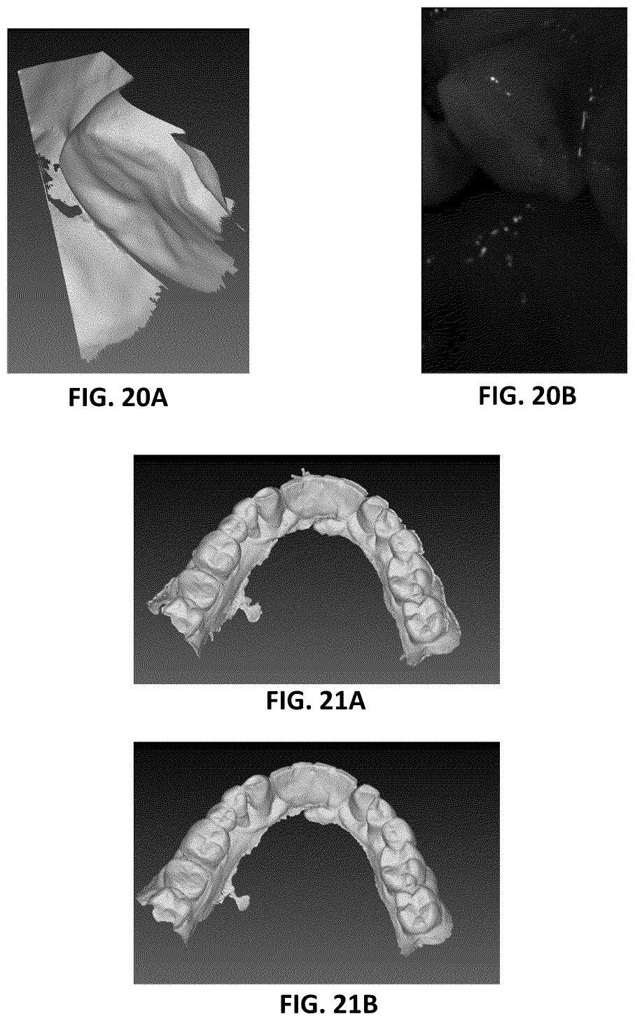

For example, FIGS. 19A-19B show lower and upper jaws, respectively, in which a simplified mesh (e.g., 2K faces) are shown, with the different color/shadings representing different cameras. From each selected image of a simplified triangle only the region which is projected to the triangle is incorporated in the final combined surface. FIG. 20A illustrates an example of a surface integrated for specific simplified triangles; the image source for the integrated surface is shown in FIG. 20B.

FIGS. 21A and 21B illustrate the results of one example, showing that the final 3D model is smoother, and emphasizes features of the dentition; transient features (e.g., saliva bubbles and similar artifacts) are reduced or eliminated. FIG. 21A shows the results when using white light images. FIG. 21B shows results from the intraoral scan.

Use with Confocal Images

The concepts embodied as the methods and apparatuses described herein may be used in combination with any volume-generating scan, including but not limited to structured light. For example in some cases confocal images may be taken using an intraoral scanner, which may illuminate using a non-uniform illumination pattern (e.g., checkerboard, etc.) that is not necessarily structured light, but may be used to generate digital surface model information. For example, non-uniformly illuminated white-light image (e.g., confocal image) may be used to generate surface volume (e.g., 3D surface volume) information by an intraoral scanner.

In some examples patterned illumination used to generate a digital surface volume may be a patterned confocal image. For example a patterned illumination system using confocal imaging may provide an imaging of the pattern onto the object being probed and from the object being probed to the camera. The focus plane may be adjusted in such a way that the image of the pattern on the probed object is shifted along the optical axis, preferably in equal steps from one end of the scanning region to the other. The probe light incorporating the pattern may provide a pattern of light and darkness on the object. When the pattern is varied in time for a fixed focus plane then the in-focus regions on the object may display an oscillating pattern of light and darkness. The out-of-focus regions may display smaller or no contrast in the light oscillations. Light incident on the object may be reflected diffusively and/or specularly from the object's surface (however, in some cases the incident light may penetrate the surface and is reflected and/or scattered and/or gives rise to fluorescence and/or phosphorescence in the object). The pattern of the patterned light illumination may be static or time-varying. When a time varying pattern is applied, a single sub-scan can be obtained by collecting a number of 2D images at different positions of the focus plane and at different instances of the pattern. As the focus plane coincides with the scan surface at a single pixel position, the pattern may be projected onto the surface point in-focus and with high contrast, thereby giving rise to a large variation, or amplitude, of the pixel value over time. For each pixel it is thus possible to identify individual settings of the focusing plane for which each pixel will be in focus. By using knowledge of the optical system used, it is possible to transform the contrast information vs. position of the focus plane into 3D surface information, on an individual pixel basis. Thus, in some cases the focus position may be estimated by determining the light oscillation amplitude for each of a plurality of sensor elements for a range of focus planes. For a static pattern, a single sub-scan can be obtained by collecting a number of 2D images at different positions of the focus plane. As the focus plane coincides with the scan surface, the pattern will be projected onto the surface point in-focus and with high contrast. The high contrast gives rise to a large spatial variation of the static pattern on the surface of the object, thereby providing a large variation, or amplitude, of the pixel values over a group of adjacent pixels. For each group of pixels it is thus possible to identify individual settings of the focusing plane for which each group of pixels will be in focus. By using knowledge of the optical system used, it is possible to transform the contrast information vs. position of the focus plane into 3D surface information, on an individual pixel group basis. Thus, the focus position may be calculated by determining the light oscillation amplitude for each of a plurality of groups of the sensor elements for a range of focus planes. A 3D digital model may therefore be used with the confocal patterned light images. For example, a 3D surface structure of the probed object can be determined by finding the plane corresponding to the maximum light oscillation amplitude for each sensor element, or for each group of sensor elements, in the camera's sensor array when recording the light amplitude for a range of different focus planes. The focus plane may be adjusted in equal steps from one end of the scanning region to the other. Preferably the focus plane can be moved in a range large enough to at least coincide with the surface of the object being scanned.

In any of these cases the methods and apparatuses may identify edges in the un-patterned illumination image taken from an intraoral scan and determining a location of one or more cameras corresponding to a patterned illumination image taken during the intraoral scan. These methods may also generate a depth map for the one or more cameras corresponding to the patterned illumination image, identifying edges in the depth map, and may determine an alignment transform to align edges identified from the un-patterned illumination image with edges identified from the depth map. The 3D model that is derived from the patterned illumination images of intraoral scan may be modified using the alignment transform and the un-patterned illumination image, as described above.

### Normals for Global Correction of 3D Models

As mentioned above, the methods and apparatuses described herein may modify a 3D digital model of a subject's dentition/oral cavity (e.g., teeth and/or gingiva and/or palate) using surface normals, and a corresponding normals map, identified from one or more 2D images of the subject's oral cavity corresponding to all or region (or sub-region) the 3D digital model. For example, the method, or an apparatus for performing the method, may include starting with a 3D digital model (e.g., a mesh model, such as a triangular mesh model) of the subject's oral cavity. In some cases, the method may include identifying one or more regions to be corrected and/or dividing the 3D model into one or more sub-regions to be corrected. The method may further include identifying one or more 2D images corresponding to the 3D model (or the region/sub-region of the 3D model being corrected). The method (or apparatus performing the method) may then determine (e.g., by estimating, calculating, etc.) a surface normal for each face, e.g., each triangle, of the region of the 3D model being corrected with the corresponding 2D image(s). The surface normal is perpendicular to the face of the triangle. The 3D model of the subject's oral cavity may be represented as a series of triangles forming a manifold; one or more of the edges (and therefore two vertices) for each triangle of the 3D model (or region/subregion being modified in some examples) is shared by an adjacent triangle of the manifold. The manifold, including these shared vertices, at the boundaries of the manifold of the 3D model as well as within eh interior of the manifold, may act as constraints when modifying the normals of the 3D model from the normal map of the one or more corresponding 2D images, as will be described in greater detail below.

A surface normal map may also be generated from the one or more corresponding 2D image(s). corresponding 2D images may be identified as described above. In particular, 2D images may be selected from the same data set of images (e.g., intraoral scan images) used to generate the original 3D model being modified or taken concurrently with the images/scan used to generate the 3D model. One or more images showing the same region (or sub-region) of the 3D image may be identified. A normals map may then be derived from the identified one or more images. The normals map for each one or more 2D image(s) may include a plurality of estimated normals (target normals). The target normals may be determined for each pixel in the image, or a sub-set of pixels (e.g., corresponding to the region of the 3D model being corrected). Alternatively, target normals may be generated in a density map. In some cases, the target normals may be generated by a trained machine learning agent (e.g., neural network). The trained machine learning agent may receive as input the corresponding 2D image and may output the normals map for the 2D image. The output may be tailored to the comparison with the normals of the 3D mesh model. For example, the apparatus or method may take a 2D image corresponding to the 3D model (or a region/subregion of the 3D model) and output a normals image map including a target normal for each pixel of the 2D image for comparison to normals from the desired surface of the 3D mesh model. In some cases this output include the image as well as a density map for the target normals.

The resulting target normals mapping from the 2D image(s) may then be used to modify the 3D mesh model surfaces by comparing normals for each triangular mesh of the 3D mesh model (or a region or sub-region thereof) to the target normals for a corresponding region from the 2D image(s). The manifold from the 3D surface may be used. The method or apparatus may modify or adjust the positions of the (e.g., calculate) shared vertices from the manifold for adjacent faces of the 3D mesh model to best match the target normals from the normals map(s) of the one or more 2D images. The new positions of vertices for these triangular meshes may result in new surface/mesh normals that, on the whole (e.g., globally) best fit the target normals from the normals map(s).

The modification of the vertices of the manifold to best match the normals mapping may be performed solving sparse linear equations describing the cost function and may provide a very rapid and robust technique. Although other numerical schemes may be employed, other techniques are generally slower and less stable. Thus, the optimal vertices positions which result in a best match for normals corresponding each face of the normal, may be handled by a numerical optimizer using a cost function and minimizing the angles between the calculated/adjusted normals and the estimated normals from the normals map(s).

By adjusting the vertices of the manifold so that the normals of the triangular mesh faces of the 3D model best match the estimated or target normals, these new positions of the vertices may be adjusted globally, avoiding discontinuities. This is because the technique is constrained by the shared vertices forming the manifold. For example, in some cases the numeric scheme may require computation of the modified normal angles and may result in dividing by a unit length of the perpendicular direction, in order to calculate cost function the numeric scheme may have to divide by a value approaching zero, requiring more complexity and computational power to resolve. In contrast the methods and apparatuses described herein may instead use sparse linear equations that can be quickly and efficiently solved. This is described in greater detail below.

The methods and apparatuses described herein may also be particularly useful for retaining details of the subject's oral cavity, especially when capturing (e.g., scanning, by intraoral scanner) in relatively high magnification. The use of 2D images taken with (or as part of) the scan to refine the resulting 3D model as described herein may further preserve details that may be otherwise lost when correcting a 3D model. Displacing the vertices of the 3D mesh model as described herein may provide a global optimization while avoiding discontinuities, even in regions for which the 2D image may not provide surface normals. In some cases the derivative of the normals may be used to provide or enhance continuity across a manifold.

FIG. 24 illustrates one example of a method for modifying (e.g., correcting, adjusting, etc.) a 3D digital model of a subject's dentition/oral cavity using normals from one or more 2D images of corresponding regions of the subject's dentition/oral cavity. For example, improving a 3D mesh model of the subject's dentition may include using normals derived from a 2D image. The method (or an apparatus performing the method) may access a 3D digital model of the subject's dentition 2401. Accessing may include receiving and/or generating, including in some cases taking an intraoral scan. Optionally, in some cases the methods described herein may be performed while taking the intraoral scan (in real, or near-real time), and/or after taking the intraoral scan. In some examples the apparatus may be part of an intraoral scanner or functionally connected to the intraoral scanner. The 3D model (e.g., 3D mesh model) may be generated or converted into a mesh (e.g., triangular mesh) model.

The method (or apparatus performing the method) may also access a plurality of 2D “reference” images of the same dentition 2403. As mentioned, accessing may include receiving and/or generating the 2D images. These 2D images may be all or a subset of the images taken during the same scan used to generate the 3D model. In some cases the reference images may be taken concurrently with the images used to generate the scan. The reference images may be the same imaging modality as the images used to generate the 3D model, or they may be different (e.g., white light, light for generating fluorescent images, near-IR light, etc.).

Optionally, these methods may include determining one or more region (sub-regions) of the 3D digital model to modify using this method 2405. For example, as described in greater detail above, these methods may include detecting or determining (automatically, semi-automatically or manually) one or more gaps, holes, artifacts, inaccuracies, etc. In some cases a region or regions of particular interest in the 3D model may be modified by this technique (e.g., all or a subset of the teeth, the crowns, the interproximal regions, the gingival, etc.). In some cases the entire 3D model may be modified as described herein.

In some embodiments the 3D digital model may be divided up into a plurality of sub-regions (e.g., regions to be modified) 2407. Thus, the 3D model may be modified iteratively, including multiple passes over the same region(s) and/or sequential correction of a variety of different regions.

In general, the 3D digital model may be corrected 2409 by modifying the 3D digital model (from an initial 3D digital model, or 3D digital mesh model (triangular mesh) to a modified or improved 3D digital model/3D digital mesh model. As an initial step, one or more 2D reference images showing the object(s) of the 3D digital mesh model (e.g., teeth, gingiva, etc.) or of the sub-region of the 3D digital model. The reference images may be selected as described above, including using a trained machine learning agent to identify one or more 2D reference images. These images may be unprocessed or pre-processed (e.g., cropped, contrast adjusted/normalized, etc.). Reference images may be matched to one or more corresponding regions of the 3D model.

Any of these methods and apparatuses may include extracting normals from 2D Image 2413. For example, these methods may use techniques like photometric stereo, shape-from-shading, or deep learning models to estimate surface normals from a 2D image. These normals may represent how the surface is oriented in 3D space from the image's perspective. The density of the normals estimated may be predetermined, e.g., per pixel, per region, based on relative changes in the vector direction (e.g., surface curvature). A 2D image surface module may be used to estimate the normals for the 2D image and may include the trained machine learning agent mentioned above. The output of the 2D normals module may be a normals map (optionally including the 2D image) and may be mapped directly or indirectly onto the 3D mesh model.

The methods and apparatuses may also compute normals from the 3D mesh model 2415. The steps of generating the normals map(s) and computing normals from the 3D mesh model may be performed in any order, or at the same time. For each face in the 3D mesh model, the method or apparatus may compute the current face normal, e.g., using the cross product of its edges. This may provide the actual orientation of the mesh surface before refinement (or as an intermediate step of modification when iteratively performed). The mesh surface forms a manifold having vertices and triangular faces for which the normal rays (perpendicular to the triangular faces) are estimated.

The method (and apparatus performing the method) may then solve for displacements of the vertices of the 3D mesh model (e.g., the manifold representing at least a region of the 3D mesh model) 2417 by comparing the target normals with the surface normals of the 3D mesh model. For example, for each face, the method may include comparing the target normal (estimated from the 2D image(s)) with a current surface normal of the 3D mesh. The difference between these normals may indicate how the mesh needs to be adjusted or corrected to best correspond with the 2D images. The method may include defining displacement directions for the vertices. For example, these methods and apparatuses may may determine how each vertex in the mesh should move, e.g., along the vertex normal, and/or along an average ray direction from a camera to the vertex, which may optionally be used for image-based normals. In some cases, this direction may be used to express the displacement as a scalar value per vertex.

The methods and apparatuses may then set up the optimization problem in order to relate vertex displacements to the desired (target) face normals for the 3D mesh (or the corresponding manifold). In particular, this may include setting ups a sparse linear equation corresponding to the displacement as well and boundary conditions. For example, for each triangle and edge, the method or apparatus may derive constraints that ensure the displaced mesh will produce the corrected normals corresponding to normals from the normals map(s). These equations and constraints may be assembled into a global cost function. This process may be referred to as a displacement map related to the normals map(s). A displacement field displacing each vertex by some distance may be established. A cost function for the entire surface may minimize the error per edge of the triangular mesh. For example, the apparatus may determine weights, e.g., using a cotangent Laplacian. Boundary conditions may be set to prevent stretching of the surface. The displacement mapping module may be configured to build a set of equations (e.g., Poisson equations) for the displacement field. This may result in a sparse linear equation (or system of equations) having a coefficient matrix with a relatively small number of non-zero entries.

The methods or apparatuses described herein may then solve these linear equations for the displacements 2419. For example, these methods may solve the optimization problem (as a linear system) to find the scalar displacement for each vertex. The solution may minimize the difference between the mesh's new normals and the target normals, with optional regularization to smooth the result. These methods and apparatuses may apply the displacement to the manifold (e.g., the 3D mesh model), e.g., to move each vertex along its defined direction by the computed displacement amount. This may update the mesh geometry to better match the image-derived normals. If the direction of displacement is not known, in some cases the method and apparatus may extend the optimization to solve for full 3D displacement vectors. This may allow for more flexible deformation, particularly when normals are sampled from multiple views. The boundary conditions may then be applied, which may prevent unrealistic stretching or distortion by applying constraints at the mesh boundaries. These conditions may ensure smooth transitions and preserve the overall shape integrity. In general, this process may allow refining of a 3D mesh using rich information from a 2D image, improving realism and accuracy.

In general, these methods may include per-vertex displacements such that the resulting mesh has a desired set of face normals, by computing a displacement field over a triangular mesh such that the displaced surface best matches the set of target normals (e.g., from the 2D images). Each vertex may be displaced along a direction (typically along its normal), and vertex positions are adjusted so that the resulting face normals best match the target normals. For example, for a triangle face with vertices (i, j, k), and edges between the vertices, the displacement of each vertex may be projected along the face normal and/or the edge direction. As mentioned, constraint equations may be derived from the geometric relationships between displaced vertices and target normals and expressed as a set of linear equations in which coefficients may be based on geometry and target normals. Optimization may be performed using a set of global least-squares cost functions that may include a weight (e.g., cotangent of opposite angle) and a regularization term (e.g., based on vertex area). These equations may be generalized to solve for full 3D displacement. As mentioned, boundary constraints may prevent surface stretching. In general, these methods and apparatuses for performing them may provide a robust way quickly and efficiently modify a 3D digital model and output the modified 3D digital model 2421.

In general, the output may be transmitted, stored and/or displayed. Outputting may include any of these. In some cases outputting may include forming one or more dental appliances (including manufacturing such appliances, e.g., using direct fabrication techniques), as described above.

As used herein, a processor includes hardware that runs the computer program code. Specifically, the term ‘processor’ may include a controller and may encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

All publications and patent applications mentioned in this specification are herein incorporated by reference in their entirety to the same extent as if each individual publication or patent application was specifically and individually indicated to be incorporated by reference. Furthermore, it should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method, the method comprising:
accessing a three-dimensional (3D) digital mesh model of a subject's dentition;
accessing one or more two-dimensional (2D) reference images corresponding to at least a region of the 3D digital mesh model;
generating a surface normal map comprising target normals from the one or more 2D reference images;
computing surface normals for corresponding regions of the 3D digital mesh model;
comparing the surface normals from the 3D digital mesh model and the target normals from the surface normal map to determine a displacement of vertices of the 3D digital mesh to minimize the differences between the surface normals from the 3D digital mesh model and the target normals from the surface normal map; and
modifying the 3D digital mesh model using the determined displacement of vertices.

2. The method of claim 1, wherein comparing the surface normals and the target normals comprises solving a sparse linear equation system to optimize displacement of vertices of the 3D digital mesh that minimizes a cost function representing a difference between the surface normals from the 3D digital mesh model and the target normals from the surface normal map.

3. The method of claim 1, wherein the surface normal map is generated using a trained machine learning model configured to estimate normals from the 2D reference images.

4. The method of claim 1, wherein the displacement of vertices is constrained by shared vertices of adjacent faces in the mesh.

5. The method of claim 2, wherein the cost function includes a regularization term based on vertex area and a weight term based on cotangent Laplacian.

6. The method of claim 1, wherein a direction of displacement for each vertex is defined along a vertex normal or along a ray from a virtual camera to the vertex.

7. The method of claim 1, further comprising dividing the 3D digital mesh model into a plurality of sub-regions and applying the method iteratively to each sub-region.

8. The method of claim 1, wherein the 2D reference images are obtained concurrently with or as part of an intraoral scan used to generate the 3D digital mesh model.

9. The method of claim 1, wherein the 3D digital mesh model includes both external and internal surfaces derived from visible and near-infrared imaging modalities.

10. The method of claim 1, wherein the output of the modified 3D digital mesh model is used to fabricate a dental appliance.

11. A method, the method comprising:
accessing a three-dimensional (3D) digital mesh model of a subject's dentition;
accessing one or more two-dimensional (2D) reference images corresponding to at least a region of the 3D digital mesh model;
generating a surface normal map comprising target normals from the one or more 2D reference images;
computing surface normals for corresponding regions of the 3D digital mesh model;
determining a displacement of vertices of the 3D digital mesh that minimizes a cost function including a difference between the surface normals from the 3D digital mesh model and the target normals from the surface normal map;
modifying the 3D digital mesh model using the determined displacement of vertices; and
outputting the modified 3D digital mesh model.

12. A system, the system, comprising:
an intraoral scanner configured to generate an initial three-dimensional (3D) digital mesh model of a subject's dentition;
a processing unit comprising a memory storing computer-program instructions, that, when executed by the one or more processors, perform a computer-implemented method comprising:
accessing the 3D digital mesh model of the subject's dentition;
accessing one or more two-dimensional (2D) reference images corresponding to at least a region of the 3D digital mesh model;
generating a surface normal map comprising target normals from the one or more 2D reference images;
computing surface normals for corresponding regions of the 3D digital mesh model;
comparing the surface normals from the 3D digital mesh model and the target normals from the surface normal map to determine a displacement of vertices of the 3D digital mesh to minimize the differences between the surface normals from the 3D digital mesh model and the target normals from the surface normal map; and
modifying the 3D digital mesh model using the determined displacement of vertices.

13. The system of claim 12, wherein comparing the surface normals and the target normals comprises solving a sparse linear equation system to optimize displacement of vertices of the 3D digital mesh that minimizes a cost function representing a difference between the surface normals from the 3D digital mesh model and the target normals from the surface normal map.

14. The system of claim 12, wherein the surface normal map is generated using a trained machine learning model configured to estimate normals from the 2D reference images.

15. The system of claim 12, wherein the displacement of vertices is constrained by shared vertices of adjacent faces in the mesh.

16. The system of claim 15, wherein the cost function includes a regularization term based on vertex area and a weight term based on cotangent Laplacian.

17. The system of claim 12, wherein a direction of displacement for each vertex is defined along a vertex normal or along a ray from a virtual camera to the vertex.

18. The system of claim 12, further comprising dividing the 3D digital mesh model into a plurality of sub-regions and applying the method iteratively to each sub-region.

19. The system of claim 12, wherein the 2D reference images are obtained concurrently with or as part of an intraoral scan used to generate the 3D digital mesh model.

20. The system of claim 12, wherein the 3D digital mesh model includes both external and internal surfaces derived from visible and near-infrared imaging modalities.
